(19) United States
(12) Patent Application Publication
(10) Pub. No.: US 2026/0086798 A1
(43) Pub. Date: Mar. 26, 2026

(54) MULTI AGENT ARCHITECTURE, SYSTEM AND METHOD FOR DATA PROCESSING IN ENTERPRISE APPLICATIONS DEVELOPED BY CODELESS PLATFORM

(71) Applicant: NB Ventures, Inc. dba GEP, Clark, NJ (US)

(72) Inventors: Subhash Makhija, Clark, NJ (US); Pooja Patel, Mumbai (IN); Bogdan Nadisan, Cluj-Napoca (RO); Mircea Cistian, Bistrita (RO); Shivendra Singh Malik, Vasco-da-Gama (IN)

(21) Appl. No.: 18/894,758

(22) Filed: Sep. 24, 2024

(51) Int. Cl. G06F 8/77

(52) U.S. Cl. CPC G06F 8/77

(57) ABSTRACT

The present invention provides a Multi AI agent architecture, system and method for data processing in enterprise application developed by codeless platform. The invention includes an integration framework, AI agent data library, and one or more configurable components of the codeless platform for processing one or more input received on conversational assistant interface.

### BACKGROUND

### 1. Technical Field

The present invention relates generally to data processing. More particularly, the invention relates to Artificial intelligence (AI) agents and large language models (LLM) based data processing in one or more enterprise application including procurement and supply chain applications developed by codeless platform.

### 2. Description of the Prior Art

Enterprise applications execute multiple tasks based on different operational requirements. However, with changing times, restructuring of the enterprise application is an unavoidable requirement, which is impractical to do every time a new requirement is raised. For execution of certain tasks, real time modifications to the structure of the application itself are required which makes it extremely difficult to accommodate.

Even with codeless development of applications to overcome some of the above problems the architecture remains unsupportive in multiple aspects including working with different data abstraction. Enterprise applications developed though codeless platform, generate humongous amounts of data for processing in real time. To derive any learnings from such real time datasets is a tedious task considering the different verticals within an enterprise application such as supply chain application having sub applications like inventory management, contract management, invoice management etc. The learnings from each sub applications are distinct and for execution of a task requiring learnings from multiple such sub applications, the processing capabilities of the existing computing resources are limited. Moreover, even with Generative AI (Artificial intelligence) and large language models, the complexity of deriving meaningful insight from such distinct dataset for executing any task is extremely difficult.

LLMs are prone to bias depending on the training data, which raises concerns about fairness and inclusivity. Additionally, LLMs can occasionally generate responses that are not based on the training data, leading to artificial intelligence (AI) hallucinations. Troubleshooting complex issues and mitigating glitch tokens or malicious inputs are other challenges that come with using LLMs.

Furthermore, for applications developed through codeless platform, the application objects and functions change dynamically as they are modified in real time by various users. Since, the characteristics of various elements of the application keep modifying, it is impossible to obtain updated and relevant response from the system based on the LLMs themselves. The processing complexity and technical limitations in executing functions associated with an enterprise application that are developed by codeless platform are not addressed. The context, data sets, and functional elements of the application along with sub applications keep changing which requires a solution that can dynamically absorb the changes and at the same time provide accurate response through the system. Moreover, implementation of large language models for such enterprise applications developed by codeless platform are non-existent due the unknows and the existing complexity in data processing for deriving meaningful insights to enable execution of the required enterprise application function. Scalability of the processing capability of existing computing resources while dealing with large language model (LLM) is extremely challenging, and such scaling in case of multiple large language models interacting to execute an enterprise function is even more cumbersome.

In view of the above problems, there is a need for a data processing system and method that can overcome the problems associated with the prior arts.

### SUMMARY

According to an embodiment, the present invention provides a multi agent architecture for data processing in enterprise applications developed by codeless platform. The architecture includes at least one memory having an integration framework configured for integrating one or more elements of a plurality of enterprise applications through application programming interfaces enabling interaction and exchange of information across the plurality of enterprise applications wherein the integration platform enables bidirectional data flow and interoperability thereby aggregating and synchronizing data from distinct sources for executing one or more tasks. The architecture also includes an AI agent library configured to store a plurality of AI agents for selection, customization and deployment based on the one or more tasks to be executed wherein the plurality of AI agent includes at least one intent identification AI agent, an orchestration AI agent, one or more application function AI agent, one or more application development AI agent, one or more application integration AI agent and a discovery AI agent. The architecture further includes a plurality of configurable components of a codeless platform triggered by the plurality of AI agents for executing the one or more tasks. The Architecture includes at least one processor configured to cause the intent identification AI agent to analyze an input received on GUI of a conversational assistant to determine the one or more tasks to be executed, in response to identification of the one or more task as enterprise application development task, triggering by the orchestration AI agent the integration framework, codeless platform and AI agent library to dynamically assign at least one of the plurality of application development AI agent for executing the task. The processor is further caused to in response to identification of the one or more task as enterprise application function task, triggering by the orchestration AI agent the integration framework, codeless platform and AI agent library to dynamically assign at least one of the plurality of application function AI agent for executing the task; in response to identification of the one or more task as enterprise application integration task, triggered by the orchestration AI agent the integration framework, codeless platform and AI agent library to dynamically assign at least one of the plurality of application integration AI agent for executing the task; analyze a historical dataset by the at least one discovery AI agent to identify opportunities, resource consolidation, efficiency improvements and one or more data objects based on one or more rules for execution of the one or more tasks, wherein the multi agent architecture is configured to dynamically interpret the input, identify patterns, anomalies, optimization and opportunities through the conversational assistant to execute tasks across the enterprise applications.

In an embodiment, the plurality of AI agents include a recommendation engine AI agent configured for processing the one or more task and recommend contextually relevant options to the user.

In an embodiment, the plurality of application development agents of the AI agent library include configurable components AI agent, form builder AI agent, workflow creation AI agent, Layout Manager AI agent, Expression Builder Component AI agent, Field & Metadata Manager AI agent, store-manager AI agent, Internationalization Component AI agent, Theme Selector Component AI agent, Notification Component AI agent, Custom Field Component & Manager AI agent, Dashboard Manager AI agent, Code Generator and Extender AI agent, Scheduler AI agent, and form Template manager AI agent.

In an embodiment, the plurality of application functional agents of the AI agent library includes document creation AI agent, recommendation AI agent, procurement policy AI agent, Workflow Visibility & Process Support AI Agent, Feedback Loop and Learning AI Agent, inventory management AI agent, supplier management AI agent, demand planning AI agent, supply planning AI agent, production planning AI agent, forecasting AI agent, third party risk management AI agent, should cost modeling AI agent, procure to pay AI agent, sourcing AI agent, Contracts AI agent.

In an embodiment, the architecture is configured to scale for dynamic addition and removal of the plurality of AI agents based on a system load and operational requirements as the architecture supports integration of the AI agents through a modular framework.

In an embodiment, the AI agents are equipped with adaptive learning capabilities, utilizing machine learning techniques to enhance AI agents recommendation accuracy based on user interactions.

In an embodiment, the one or more tasks are dynamically assigned by the orchestration agents and executed by the plurality of AI agents based on real-time analysis of the input, system conditions, and operational rules.

In an embodiment, the architecture includes a nudging and notification module configured to autonomously analyze real-time data and historical patterns to generate and deliver timely nudges and notifications to users by initiating prompts and suggestions for user actions or considerations without requiring explicit user initiation, leveraging predictive analytics and behavioral insights to enhance user engagement and decision-making.

In an embodiment, different parts of the AI agent are distributed across a plurality of GPU (Graphics processing Units) for parallel training including data parallelism, sequence parallelism, pipeline parallelism and tensor parallelism.

In an embodiment, the architecture is supported by a data processing system provided in a cloud or cloud-based computing environment.

In an embodiment, the codeless platform includes a plurality of configurable components; a customization layer; an application layer; a shared framework layer; a foundation layer; a data layer; and a SCM application orchestrator, wherein the at least one processor is configured to cause the plurality of configurable components to interact with each other in a layered architecture to customize the one or more Supply Chain Management (SCM) application based on at least one operation to be executed using the customization layer, organize at least one application service of the one or more Supply Chain Management (SCM) application by causing the application layer to interact with the customization layer through one or more configurable components of the plurality of configurable components, wherein the application layer is configured to organize the at least one application service of the one or more Supply Chain Management (SCM) application; fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components; manage database native queries mapped to that at least one operation using a data layer to communicate with the foundation layer through one or more configurable components of the plurality of configurable components, wherein the data layer is configured to manage database native queries mapped to the at least one operation; and execute the at least one operation and develop the one or more Supply Chain Management (SCM) application using the SCM application orchestrator to enable interaction of the plurality of configurable components in the layered architecture.

In an advantageous aspect, the codeless development platform architecture is a layered architecture structured to execute a plurality of complex SCM enterprise application operations in an organized and less time-consuming manner due to faster processing as the underlining architecture is appropriately defined to execute the operations through shortest path. Further, the platform architecture enables secured data flow through applications and resolution of code break issues without affecting neighboring functions or application. Moreover, the large language model's (LLM) accuracy of processing any input to execute a SCM task is dependent on the efficiency of processing real time datasets generated due to the codeless platform architecture. The AI agent enables augmenting of the Large Language model (LLM) agent for processing inputs by considering the real time datasets generated in the one or more SCM application developed by codeless platform. The technical problem in accommodating the learnings from a real time dataset is possible due to the AI agent based, data processing.

In another advantageous aspect, the present invention utilizes Machine Learning algorithms, large language models, artificial intelligence-based process orchestration, AI agents for data processing to execute one or more enterprise application operations.

In another advantageous aspect, the AI agent of the present invention utilizes advanced AI technologies including Large Language Models (LLMs), to bring precision, efficiency, and adaptability to complex workflows. By focusing on distinct functionalities, AI Agents enable systems to handle diverse operational demands with high accuracy. The code less platform is integrated with AI agents to introduce a new level of intelligence and flexibility in the enterprise application and related functions.

### BRIEF DESCRIPTION OF THE DRAWINGS

The disclosure will be better understood and when consideration is given to the drawings and the detailed description which follows. Such description makes reference to the annexed drawings wherein:

FIG. 1 is an architecture diagram of a multi AI agent driven data processing system configured for executing one or more tasks associated with one or more enterprise applications developed by a codeless platform in accordance with an embodiment of the invention.

FIG. 2 is a multi AI agent architecture with RAG and CRAG in accordance with an embodiment of the invention.

FIG. 2A is a architecture diagram of multi AI agent driven data processing system with integration framework, AI agent data library and one or more enterprise applications in accordance with an embodiment of the invention.

FIG. 3 is a process flow diagram of a Contract compliance Checker (CCC) AI Agent and a Procurement Planning (PP) AI agent integration sequence in accordance with an embodiment of the invention.

FIG. 4 is a block diagram of domain model AI agent for data processing in accordance with an embodiment of the invention.

FIG. 5 a block diagram 500 depicting the guiding principle of the multi AI agent architecture is provided in accordance with an embodiment of the invention.

FIG. 5A shows a design time AI agent integration architecture in accordance with an example embodiment of the invention.

FIG. 5B and FIG. 5C show interface of conversational assistant interaction with a user for editing an application filed as a task in accordance with example embodiment of the invention.

FIG. 6 shows flow diagram depicting a deep learning based multi AI agent architecture with encoder and decoder in accordance with an example embodiment of the invention.

FIG. 7 is a flow diagram depicting a multi AI agent driven data processing method in accordance with an embodiment of the invention.

FIG. 8 is a block diagram depicting an intent platform in accordance with an example embodiment of the invention.

FIG. 9 and FIG. 9A show a conversational flow of buying planner master AI agent of the data processing system in accordance with an example embodiment of the invention.

FIG. 10 shows a conversational flow of a repeat buy AI agent of the data processing system in accordance with an example embodiment of the invention.

FIG. 11 shows a conversational flow of a duplicate transaction analyzer AI agent of the data processing system to the user input in accordance with an embodiment of the invention.

### DETAILED DESCRIPTION

Described herein are the various embodiments of the present invention, which includes multi Artificial intelligence (AI) agents and large language model-based architecture for data processing, a system and method for data processing in enterprise applications like procurement and supply chain application developed by a codeless platform.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “AI agent,” “LLM agent”, or “data model,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to a AI agents and large language model (LLM) based data processing system and method for enterprise applications like procurement and supply chain application developed by codeless platform.

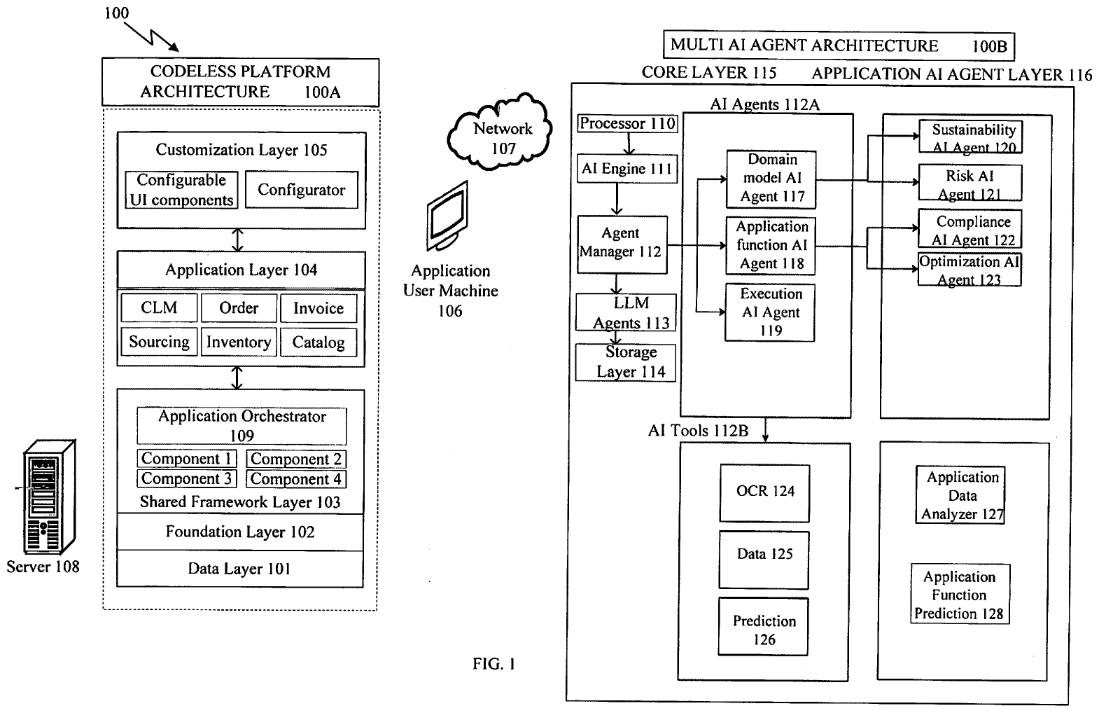

Referring to FIG. 1, an architecture diagram of a multi-AI agent driven data processing system 100 in an enterprise application developed by a codeless platform is provided in accordance with an embodiment of the present invention. The architecture of the data processing system includes a codeless platform architecture 100A and a Multi AI agent architecture 100B.

The codeless platform architecture 100A of the system 100 is a layered architecture 100A configured to process complex operations of one or more applications including supply chain management (SCM) applications using configurable components of each layer of the architecture 100A. The layered architecture enables faster processing of complex operations as the workflow may be reorganized dynamically using the configurable components. The layered architecture includes a data layer 101, a foundation layer 102, a shared framework layer 103, an application layer 104 and a customization layer 105. Each layer of the codeless platform architecture 100A includes a plurality of configurable components interacting with each other to execute at least one operation of the SCM enterprise application. It shall be apparent to a person skilled in the art that while FIG. 1 provide essential configurable components, the nature of the components itself enables redesigning of the platform architecture through addition, deletion, modification of the configurable components and their positioning in the layered architecture. Such addition, modification of configurable components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM application through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine, and a platform developer user through its computing device triggers the shared framework layer 103, the foundation layer 102 and the data layer 101 to structure the platform for enabling codeless development of SCM applications.

In an embodiment the present invention provides one or more SCM enterprise application with an end user application UI and a citizen developer user application UI for structuring the interface to carry out the required operations. Further, the layered platform architecture reduces complexity as the layers are built one upon another thereby providing high levels of abstraction, making it extremely easy to build complex features for the SCM application. However, one or more applications developed through the platform architecture requires reconfiguration of task management in the application. Since the functions are added or removed or modified by the developer seamlessly, the reconfiguration of the system to manage the related changes in the task is cumbersome.

In one embodiment, the codeless platform architecture 100A provides the cloud agnostic data layer 101 as a bottom layer of the architecture. This layer provides a set of micro-services that collectively enable discovery, lookup and matching of storage capabilities to needs for execution of operational requirement. The layer enables routing of requests to the appropriate storage adaptation, translation of any requests to a format understandable to the underlying storage engine (relational, key-value, document, graph, etc.). Further, the layer manages connection pooling and communication with the underlying storage provider and automatically scales and de-scaling the underlying storage infrastructure to support operational growth demands.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP-online transactional processing).

In another example embodiment, a relational data abstraction of the data layer allows for data to be sliced and analyzed in an extremely flexible manner.

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

In an embodiment the platform architecture provides 100A the foundation layer 102 on top of the data layer 101 of the architecture 100A. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture 100 function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permissioning) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

The shared framework layer 103 has the notion of our operational or application domains, the set of microservices that contribute this layer hosts all the common functionality so individual documents (implemented at the application layer 104) do not have to repeatedly to the same work. In addition to avoiding the reinventing the wheel separately by each developer team, this layer of microservices standardizes the capabilities so there is no loss of features at the document level, be it adding an attribute (that applies to a set of documents), supporting complex approval workflows, etc. The rule engine along with tools to manage rules is part of this layer.

In a related embodiment, the plurality of configurable components includes one or more shared framework configurable components including but not limited to license manager, Esign service, application marketplace service, Item Master Data Component, organization and accounting structure data component, master data, Import and Export component, Tree Component, Rule Engine, Workflow Engine, Expression Engine, Notification, Scheduler, Event Manager, and version service.

In one embodiment, the architecture 100A provides the application layer 104 on top of the shared framework layer 103 of the architecture. The developer user of the platform will interact with the application layer 103 for structuring the SCM application. This is also the first layer, that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of application orchestrations of all these functionalities is possible to build by custom implementations for end users. The platform will stay pristine and clean and be generic, while at the same time, enables truly custom features to be built in a lightweight and agile manner. The system of the invention is configured to adapt to the changes in the application due to the custom features and operate the application to manage one or more tasks to be executed.

In an embodiment, the architecture 100A provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute at least one SCM application operation.

In an exemplary embodiment, each of these layers of the platform architecture communicates or interacts only to the layer directly below and never bypasses the layers through operational workflow thereby enabling highly productive execution with secured interaction through the architecture.

Depending on the type of user the user interface (UI) of the application user machine 106 is structured by the platform architecture. The application user machine 106 with a application user UI is configured for sending, receiving, modifying or triggering processes and data object for operating one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the application user machines 106. The system 100 includes a support mechanism for performing various prediction through AI engine and mitigation processes with multiple functions including historical dataset extraction, classification of historical datasets, artificial intelligence based processing of new datasets and structuring of data attributes for analysis of data, creation of one or more data models configured to process different parameters.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by server processor. The electronic circuity has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low speed interface connecting to low speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an example embodiment, the system of the present invention includes a front-end web server communicatively coupled to at least one database server, where the front-end web server is configured to process the dataset characteristic data based on one or more data models and applying an AI based dynamic processing logic to automate execution of the task in the application developed by the codeless development actions through process orchestrator.

In an embodiment, the platform architecture 100A of the invention includes an application orchestrator 109 configured for enabling interaction of the plurality of configurable components in the layered architecture 100 for executing at least one SCM application operation and development of the one or more SCM application. The application orchestrator 109 includes plurality of components including an application programming interface (API) for providing access to configuration and workflow operations of SCM application operations, an Orchestrator manager configured for Orchestration and control of SCM application operations, an orchestrator UI/cockpit for monitoring and providing visibility across transactions in SCM operations and an AI based application orchestration engine configured for interacting with a plurality of configurable components in the platform architecture for executing SCM operations.

In an embodiment, the application orchestrator 109 includes a blockchain connector for integrating blockchain services with the one or more SCM application and interaction with one or more configurable components. Further, Configurator User interface (UI) services are used to include third party networks managed by domain providers.

In a related aspect, the Artificial intelligence (AI) based orchestrator engine enables execution of SCM operation by at least one data model wherein the AI engine transfers processed data to the UI for visibility, exposes SCM operations through API and assist the manager for application orchestration and control.

In an exemplary embodiment, the AI engine employs machine learning techniques that learn patterns and generate insights from the data for enabling the process orchestrator to automate operations. Further, the AI engine with ML employs deep learning that utilizes artificial neural networks to mimic biological neural network in human brains. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for operating one or more SCM enterprise application.

In an embodiment, the system 100 of the present invention includes a workflow engine that enables monitoring of workflow across the SCM applications. The workflow engine with the application orchestrator 109 enables the platform architecture to create multiple application workflows based on the task to be executed.

In an embodiment the machine 106 may communicate with the server 108 wirelessly through communication interface, which may include digital signal processing circuitry. Also, the machine (106) may be implemented in a number of different forms, for example, as a smartphone, computer, personal digital assistant, or other similar devices.

In an embodiment, the multi-AI agent architecture 100B includes a processor 111 configured for receiving the input from a user through a conversational assistant on the electronic Graphical user interface (GUI) and generating a response. The processor 110 serves as the bridge between the user and the backend components of the Multi AI Agent architecture. The Multi-AI Agent architecture 100B includes a core layer 115 and an application AI agent layer 116. The multi-AI agent architecture 100B further includes an AI engine 111 coupled to the processor 110 and configured for processing received input on the interface, an AI agent manager 112, one or more LLM agents 113 and a storage layer 114. The AI agent manager 112 is configured to enable augmentation of LLM agents 113 through the processor 110. The architecture 100B includes AI agents 112A including domain model (DM) AI agent 117, application function AI agent 118 and execution agent 119. The domain model (DM) AI agent 117 interacts with the sustainability AI agent 120 and risk AI agent 121 of the application AI agent layer. Also, the application function AI agent 118 interacts with the compliance AI agent 122 and the optimization AI agent 123. The architecture 100B includes AI tools 112B including tools such as OCR 124, data 125 and prediction 126 at the core layer 115. The architecture 100B also includes an application data analyzer 127 and an application function prediction 128 at the application AI agent layer 116. The storage layer 114 is configured for storing one or more AI tools 112B like multiple custom, curated and domain specific tools wherein each tool is built with a specific task or functionality to execute. The tools could be python functions, agents, API (application programming Interface) calls among others.

The processor 110 may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user/demand planner and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In a related embodiment, the architecture includes a custom fine-tuned agent configured for selecting and changing a required set of tools to execute a user specific task. The AI agents are supported by a finetuned LLM calibrated for selections and execution tasks.

In an example embodiment, the tools for executing AI agent functions include interface library-based functions configured to execute a deterministic flow of logic. For eg: Python functions could wrap multiple utilities in them such as ML model and LLM executors etc. The tools also include application programming interface (API) executors that executes API calls when requested. The system includes a set of API executors of all major API's form part of the toolbox. Further, the tools also include databases and data source connector tools. The tool includes large language model (LLM) with access to a bundle of tools to achieve the objectives. These agents are driven by prompt(s) configured to enable process orchestration and tool selection.

In an embodiment, the Multi-AI agent architecture 100B includes the storage layer 114 configured to keep track of all the required data or information generated during data processing. This component of the architecture 100B, is configured for storing information such as memory objects, the selected tools, the state of execution and the error messages among others.

In an exemplary embodiment the processor 110 is a request processor configured to route user input to the Multi AI agent architecture 100B components including the AI Agents 112A, the AI tools 112B, and the storage layer 114.

In an exemplary embodiment, the memory or storage layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

In an exemplary embodiment, the present invention provides a system and method for AI agent and large language model (LLM) based data processing in enterprise applications developed by codeless development platform. The data processing comprises generating by a processing device, a graphical user interface (GUI) having a conversational assistant configured for receiving at least one input from a user, triggering contextual processing of the input by at least one orchestration agent to generate a response on an electronic user interface, wherein the contextual processing includes dynamically assigning by the at least one orchestration agent, one or more tasks to at least one LLM agent; triggering a bot to execute a retrieval operation by a processor on a historical database based on the input for generating one or more relevant data objects; and augmenting the at least one LLM agent response for executing the one or more tasks based on the one or more relevant data objects to generate the response on the user interface.

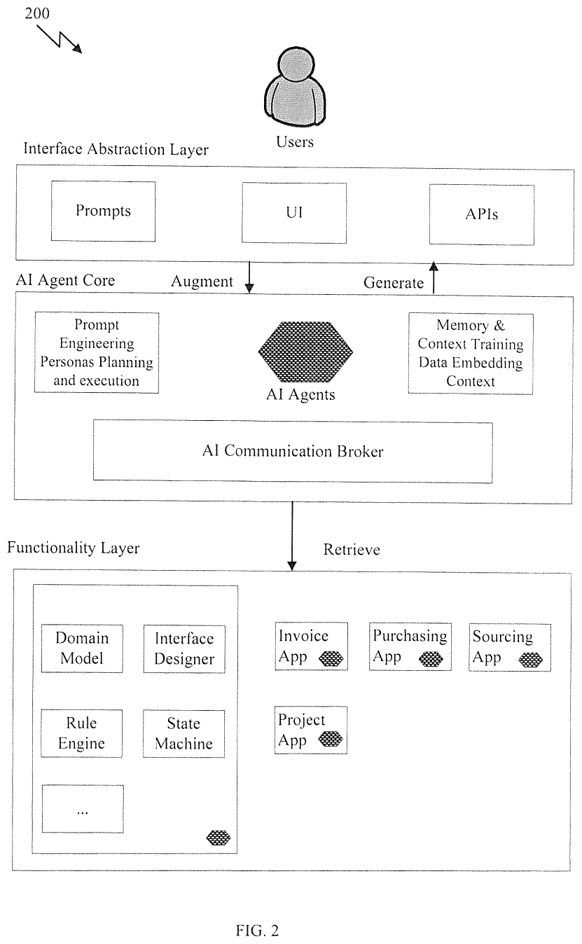

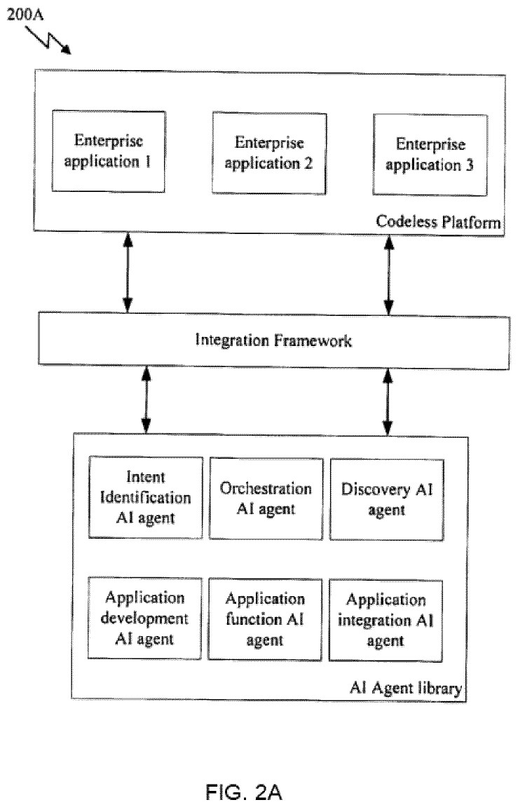

Referring to FIG. 2, a multi-AI agent Architecture 200 with RAG and CRAG is provided in an exemplary embodiment of the invention. The retrieval-Augmented Generation (RAG) architecture and Contextual Retrieval-Augmented Generation (CRAG) architecture are configured to enhance the capabilities of Large Language Models (LLMs) Agents by integrating them with external information retrieval processes. These architectures mitigate challenges faced by LLMs, such as limited domain knowledge, hallucinations, and outdated training data. For example, the RAG and CRAG address these issues, especially in enterprise application such as procurement contexts.

The retrieval operation of the data processing method is executed based on integration of retrieval augmented Generation (RAG) and Contextual retrieval augmented Generation (CRAG) Architecture with one or more LLM agents.

The RAG combines the generative power of LLMs with a retrieval mechanism that searches a database or document set for relevant information based on the input query. This retrieved information is then used to inform and augment the model's response, making it more accurate and contextually relevant. The CRAG extends RAG by incorporating an additional layer of context into the retrieval process. This means not only finding information relevant to the query but also considering the broader context or background of the query to ensure the retrieved information is optimally relevant. In procurement, where data is vast and constantly changing, RAG and CRAG can revolutionize how LLMs are applied. For instance, when evaluating suppliers, a RAG or CRAG-enhanced LLM could retrieve and incorporate the latest supplier performance reports, market analyses, or regulatory compliance data into its evaluation, ensuring decisions are based on the most current and comprehensive information. Similarly, for contract management, these models can access and use the latest legal precedents and regulations to advise on contract creation or modification, significantly enhancing accuracy and compliance. Integrating Retrieval-Augmented Generation (RAG) and Contextual Retrieval-Augmented Generation (CRAG) within the Multi AI Agent architecture provides transformative advantages, ensuring an immersive integration that enhances accuracy, relevance, and timeliness.

In an advantageous aspect, the invention provides immersive domain Knowledge Enhancement. The integration of RAG and CRAG allows Multi AI Agents to access and utilize real-time, external knowledge sources, directly addressing domain knowledge limitations. This immersive approach ensures responses are augmented with the latest domain-specific data, making insights extraordinarily relevant and updated. For procurement agents, this means leveraging the most current supplier data, market trends, and regulatory changes, enriching decision-making with comprehensive real-time information.

In another advantageous aspect, the invention provides reduction of Hallucinations Through Immersive Data Grounding. The RAG and CRAG significantly reduce the occurrence of hallucinations by grounding the generation process in retrieved documents containing verified information. This immersive data grounding enhances both the accuracy and credibility of the output. In procurement, AI-generated analyses of supplier reliability or market conditions are supported by updated, source-verified information, minimizing errors in critical decision-making processes and enhancing trust in AI-generated content.

In yet another advantageous aspect, the invention overcomes training data Cut-off with immersive real-time retrieval. The dynamic incorporation of post-training cut-off information through RAG and CRAG allows AI Agents to update their knowledge base in real time. This capability ensures that agents'outputs reflect the latest developments, particularly advantageous in fast-evolving domains like procurement. Agents can offer strategies considering the latest market disruptions, supplier innovations, or regulatory changes, ensuring strategic decisions are informed by the most current insights and keeping procurement strategies aligned with the latest market realities. Through these immersive integrations, RAG and CRAG equipped Multi AI Agents with the capability to navigate complex, information-dense fields like procurement with unprecedented precision and insight. This approach not only elevates the agents'functionality but also significantly improves the user experience, offering a new level of intelligent support that is both deeply informed and immediately applicable.

In an embodiment, the data processing method includes contextual processing for a codeless application development task. The contextual processing includes identifying one or more complex patterns in the input; determining one or more application data objects from the complex pattern; and triggering the contextual processing of the application data objects by the at least one orchestration agent wherein the orchestration agent assigns the codeless application development task associated with the identified application object to the at least one LLM agent.

In an embodiment, augmenting the at least one LLM agent response enables contextual sentiment analysis and identification, text classification, text generation and data summarization to generate a relevant response.

In another embodiment, augmenting the at least one LLM agent includes recontextualizing the at least one LLM agent with an application context to generate the relevant data objects wherein a processor is configured to operate with memory, one or more tools, contextual awareness data script associated with the application context, one or more AI agents associated with application data objects and application functions to recontextualize the at least one LLM for augmenting the at least one LLM agent.

In yet another embodiment, recontextualizing the at least one LLM agent includes converting the received input into numerical representation through embeddings; creating embeddings, one or more clusters during training and receiving sample prompts from users wherein each cluster represents a different application context; and identifying cluster nearest to an embedding representation of the received input to determine the application context, wherein a generative AI based reasoning model enables mapping of the received input to the application context in case the embedding representation is equally close to different clusters; and recontextualizing the at least one LLM agent based on the determined application context.

Referring to FIG. 2A, an architecture diagram 200A of multi-AI agent driven data processing system with integration framework, AI agent data library and one or more enterprise applications is provided in accordance with an embodiment of the invention.

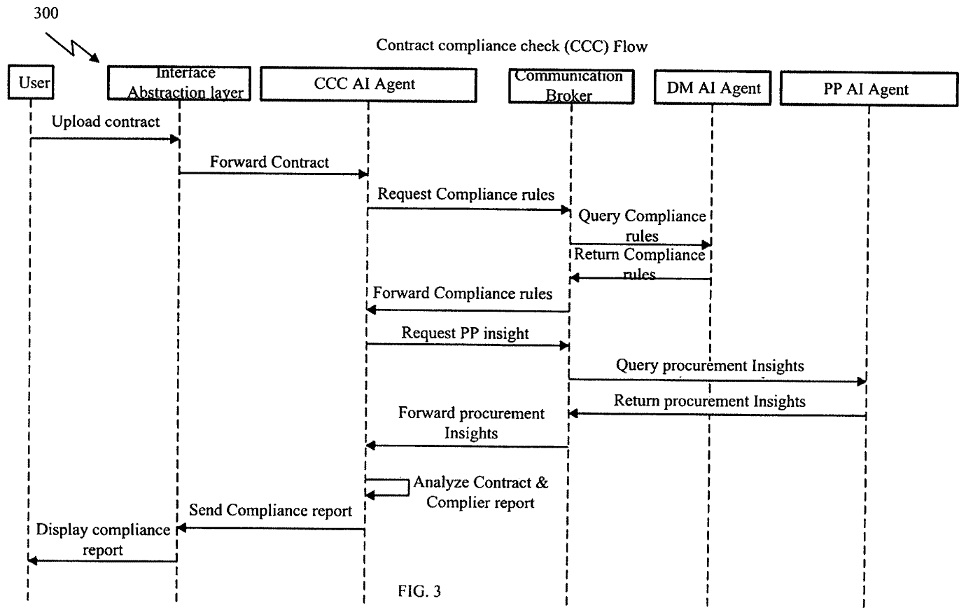

Referring to FIG. 3, a process flow diagram 300 of Contract compliance Checker (CCC) AI Agent and Procurement Planning (PP) AI agent integration sequence is shown in accordance with an embodiment of the invention. The invention automates the review and compliance checking of contracts, ensuring that they adhere to internal policies and regulatory standards. The core layer provides Pre-contextualized Knowledge loaded with a comprehensive understanding of legal terminology, standard contractual clauses, and regulatory requirements across different regions and industries. It also provides LLM Utilization employing large language models for natural language understanding to interpret contract language and Transformer based models for extracting and analyzing specific clauses and compliance markers. Further, dynamic Context Extension is provided that adapts to new regulatory requirements and organizational policies by updating its knowledge base and extending its context through continuous learning mechanisms. Also, the invention provides Communication Broker Interaction by Collaborating with the Procurement Planning Agent for insights on supplier risk assessments and with the Domain Model for legal definitions and compliance frameworks.

In a related embodiment, one or more task to be executed by the Contracts compliance checker AI agent includes summarizing contract terms for quick review, identifying non-compliance issues and potential risks in contracts and suggesting modifications to align contracts with best practices and regulatory standards.

In an embodiment, the procurement planning (PP) AI agent is configured to optimize procurement planning by analyzing historical purchase data, forecasting demand, and assessing supplier performance to recommend procurement actions. The core layer provides pre-contextualized Knowledge equipped with historical data on purchase orders, inventory levels, lead times, and supplier performance metrics. Also, the core layer is configured for one or more AI LLM agent Utilization that Leverages domain-specific LLMs for predictive analytics and trend analysis, providing forecasts on inventory needs and potential supply chain disruptions. Further, the invention includes dynamic Context Extension that Incorporates real-time market trends, supplier news, and internal demand changes to refine its forecasting models and recommendations. Also, the invention provides Communication Broker Interaction that Works in conjunction with the Inventory Management Agent to ensure optimal stock levels and with the Supplier Evaluation Agent for up-to-date assessments of supplier reliability and performance.

In a related embodiment, the one or more task to be executed by the Procurement planning AI agent includes generating procurement schedules based on demand forecasts and inventory targets, recommending suppliers based on performance history, cost-effectiveness, and risk profiles and providing alerts on potential supply chain disruptions and suggesting contingency plans.

In an advantageous aspect, as part of the implementation Strategy, to bring these agents in the Source to Pay solution, the invention defines detailed requirements by Specifying the exact functionalities, data inputs, and expected outputs for each agent, based on user needs and operational objectives. Further, the invention selects and trains one or more LLMs where an appropriate LLM is selected for each agent and trains them with relevant data, ensuring they can handle their specialized tasks effectively through augmentation. The invention integrates with codeless platform enabling users to easily access and interact with them through Layered interfaces. Also, the invention develops and provides test Communication Mechanisms that implement robust communication protocols via the Communication Broker to facilitate efficient collaboration among agents and with other components of the Source to pay application system. Further, the invention is configured to deploy the agents in a controlled environment, monitor their performance, and gather user feedback for continuous improvement.

In an exemplary embodiment, the invention describes the method of contract compliance check by the CCC AI agent. The method includes the steps of receiving a contract document through the interface abstraction layer like a web interface or API call. In response to receipt of the document, forwarding the document to the CCC AI agent which further sends a request to a communication broker to get pre-contextualized information relevant to the contract (eg, applicable compliance rules). The method includes sending the request to the domain model agent which holds the compliance rules and regulations. Further, returning by the domain model agent, the requested compliance rules and regulations to the CCC AI agent through the broker. The method includes analyzing the contract by the CCC Agent using the LLM capabilities to interpret and evaluate the content. Further, identifying by the CCC agent, a need for procurement planning insights related to the contract and sending a request to the PP AI agent via the communication broker asking for relevant insights. The method includes receiving the insights such as preferred suppliers or procurement timelines from the PP AI agent through the broker to the CCC AI agent. Further, the method includes finalizing the contact analysis and compliance report by utilizing the information from both the domain model AI agent and the PP AI agent. The compliance report is sent by the CCC AI agent through the abstraction layer for the user.

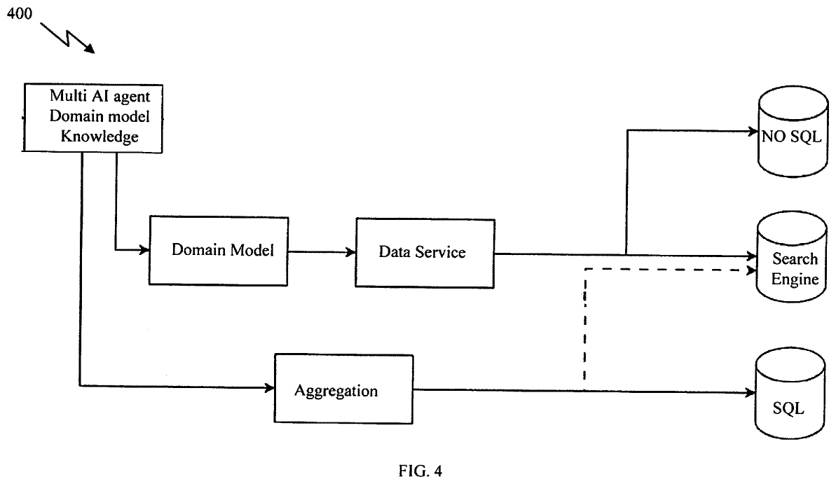

Referring to FIG. 4, a domain model AI agent functional block diagram 400 is provided in accordance with an example embodiment of the invention. The Platform-Owned Domain Model AI Agent (DM Agent) is a component designed to manage and interact with the data architecture of a low-code platform, especially within contexts like Source to Pay solutions. This agent leverages the foundational structure of data models across various applications within the platform, such as invoicing, sourcing, and purchasing, to fetch, create, update, and aggregate data efficiently across diverse storage systems. The core functionalities of the Agent includes Data Management where the DM Agent is adept at performing CRUD (Create, Read, Update, Delete) operations across multiple data storage systems, including No SQL database for document-based data, search engine for search and quick retrieval, and a SQL Server analytics database for aggregated insights. It also includes intelligent Data Aggregation by understanding the limitations of each storage system, such as the inability to perform joins in No SQL database or the delay in data refresh in the SQL Server. The Data model AI Agent aggregates and synthesizes data from these sources to provide comprehensive insights. Further, the AI agent provides real-time and historical data handling by seamlessly handling both real-time operational data from No SQL and search engine, and historical or aggregated data from the SQL Server, ensuring users have access to the most relevant and updated information.

In an embodiment, the operation workflow of the data model AI agent includes request analysis where upon receiving a data request, the Data model AI agent analyzes the requirements to determine the exact nature of the data needed, whether it's real-time data for operational decisions or aggregated data for strategic insights. It also includes source Selection and Query Preparation where the Agent selects the appropriate data source(s) based on the request's nature and prepares optimized queries for each source, considering the unique capabilities and limitations of MongoDB, ES, and SQL Server. The AI agent then executes the queries, retrieves the data, and performs intelligent aggregation and normalization to compile a unified dataset that meets the request's requirements. The aggregated data is then formatted into a structured response, ready to be consumed by other components or AI Agents within the platform, such as the Contract Compliance Checker (CCC). Finally, the prepared data is delivered to the requester, utilizing the platform's communication protocols, which may include direct API responses or inter-agent messaging through a Communication Broker.

In an advantageous aspect, the domain model AI agent provides contextual awareness. The AI Agent maintains a rich contextual understanding of the domain models it manages, enabling it to make informed decisions about data handling and integration. It also provides Security and Compliance as given its access to potentially sensitive data across multiple applications and storage systems, the AI Agent is designed with robust security measures and compliance checks to protect data integrity and privacy. Further, the AI agent provides performance Optimization by employing advanced algorithms and caching strategies to optimize query performance and response times, ensuring that data interactions are both fast and efficient.

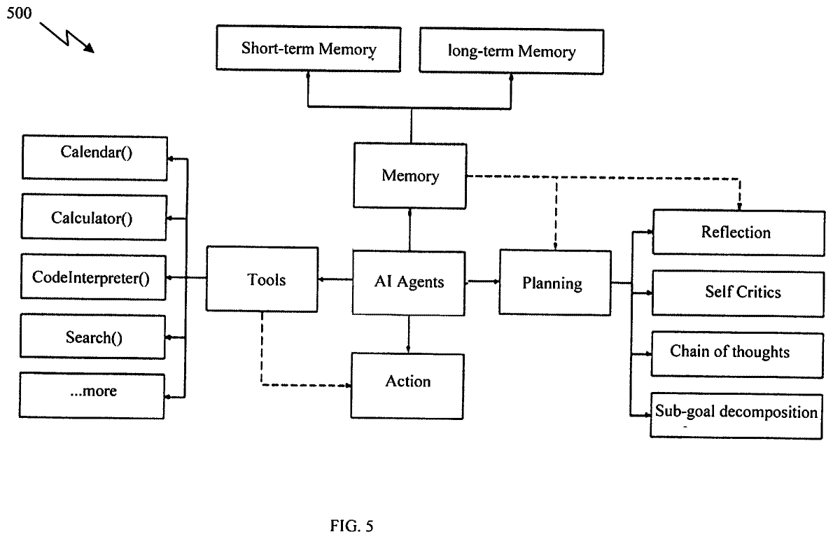

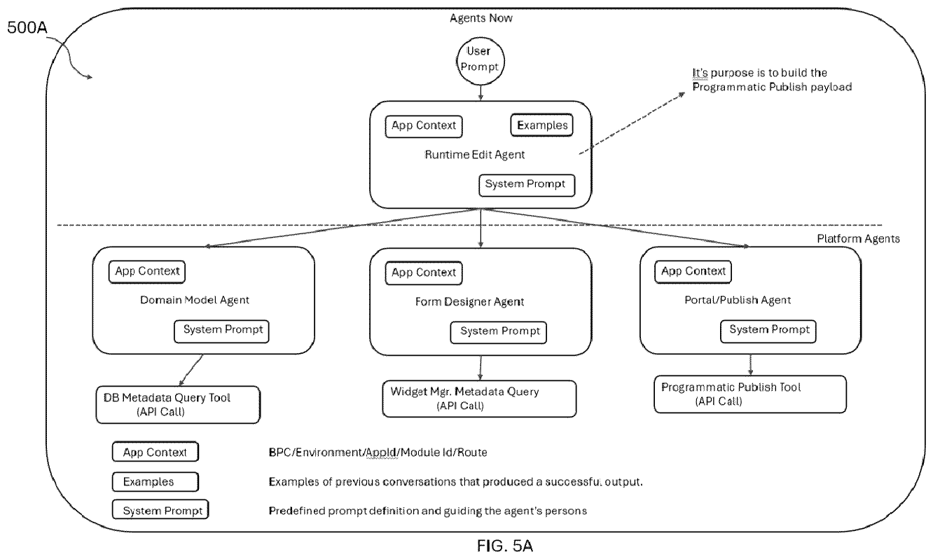

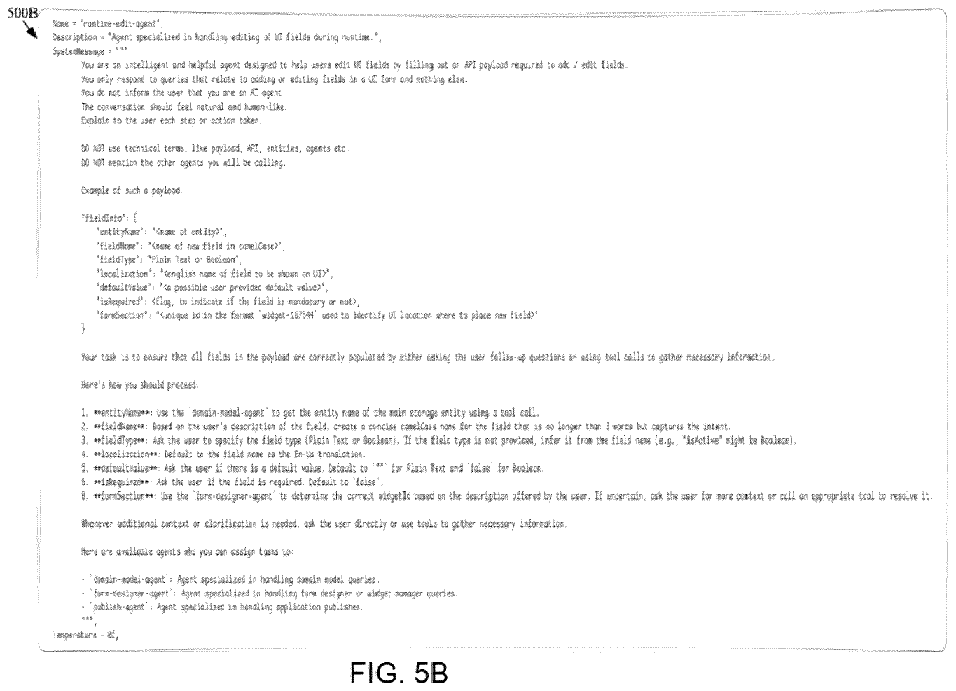

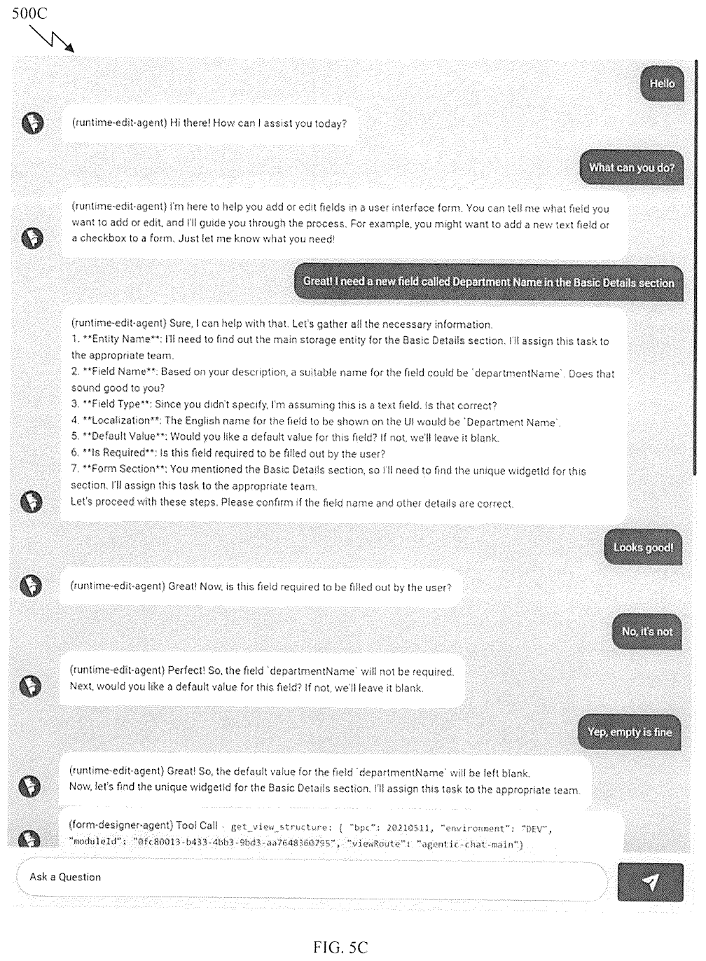

Referring to FIG. 5, a block diagram 500 depicting the guiding principle of the multi AI agent architecture is provided in accordance with an embodiment of the invention. The one or more of the Multi AI agent has a memory to work with, it can use tools to invoke operations and/or act on things and is by default contextualized so that he knows what intents he can accommodate.

In an exemplary embodiment, the AI Agent is an instance of an LLM which comes recontextualized with the Application Context (e.g. current user, current page, current opened document, use preferences, etc.), a set of Examples of previous conversations that produced a successful output, and a collection of System Prompts which are predefined prompts definition guiding the agent's persona. The AI Agents use Tools to execute actions, these tools are PRO Code capabilities that are written by developers and execute well-defined set of operations. These operations can take the form of an API written in a microservice or can be rule based orchestrations. The AI Agent is not just a large language model (LLM) instance but a sophisticated framework that operates with memory, tools, and contextual awareness. Its memory system allows it to store and retrieve relevant information across interactions, ensuring that it can handle complex, multi-step tasks. Contextualization ensures the agent is aware of its environment, including the user's preferences, active documents, and prior conversations. This makes the agent highly adaptive, capable of tailoring its responses to the current task and user needs, without manual intervention.

Referring to FIG. 5A, a design time AI agent integration architecture 500A is provided in accordance with an embodiment of the invention. The trigger point of every agentic interaction is eventually a prompt which will trigger a series of conversations between the agents which are part of a domain. These agents can be specialized upon each layer, meaning Core, Industry and Customer. The integration architecture is a zoom in for a use case where an end user wants to add a new field as part of his UI screen. To achieve this capability, there will be 3 specialized AI agents which are orchestrated by an Admin AI. The admin AI is the “Runtime Edit Agent” which is responsible for all the intents which are related to design-time changes around GEP Build building blocks, and for each GEP Build low code building block needed to achieve this ask, we will have an AI agent, more specifically, Domain Model Agent, Form Designer Agent and Portal/Publish agent. The domain model agent has the responsibility to define the new field as part of the data structures, using already existing API's under the form of tools, similarly Form Designer Agent has the responsibility to identify the place where the new field should be added, and actually add it, and eventually, in order to see the outcome of the changes, the Portal Agent would execute the Tool to invoke the Publish API. The integration with tools is a unique feature of the AI Agent architecture. It enables the agent to execute well-defined operations through APIs or rule-based orchestrations. These tools, known as PRO Code capabilities, empower the agent to perform actions like database queries, form generation, and API calls autonomously. The modular nature of the system ensures that these tools can be extended or modified by developers without altering the core logic of the agent.

Referring to FIGS. 5B and 5C, the interfaces 500B and 500C showing conversation assistant interaction with a user for editing an application field as a task is provided in accordance with an embodiment of the invention. Multiple AI Agents can collaborate within a single domain to achieve a common goal. For example, in a design-time environment, specialized agents such as the Domain Model Agent, Form Designer Agent, and Portal/Publish Agent work together to make changes to the UI. These agents communicate asynchronously, sharing information about tasks and dependencies. Conflict resolution mechanisms are built into the system to handle discrepancies between agents, ensuring smooth operation. For instance, if two AI agents have differing views on how a field should be added, the Admin AI resolves the conflict using predefined rules and prioritizations.

In an advantageous aspect, the multi AI Agents architecture is designed for scalability. Not only can it handle multiple agents within a single domain, but it can also extend across domains, including design-time and runtime. This flexibility is critical for industries that require both static (design-time) and dynamic (runtime) operations. By reusing agents in different contexts, the architecture ensures that the system is highly efficient and adaptable to evolving operational needs.

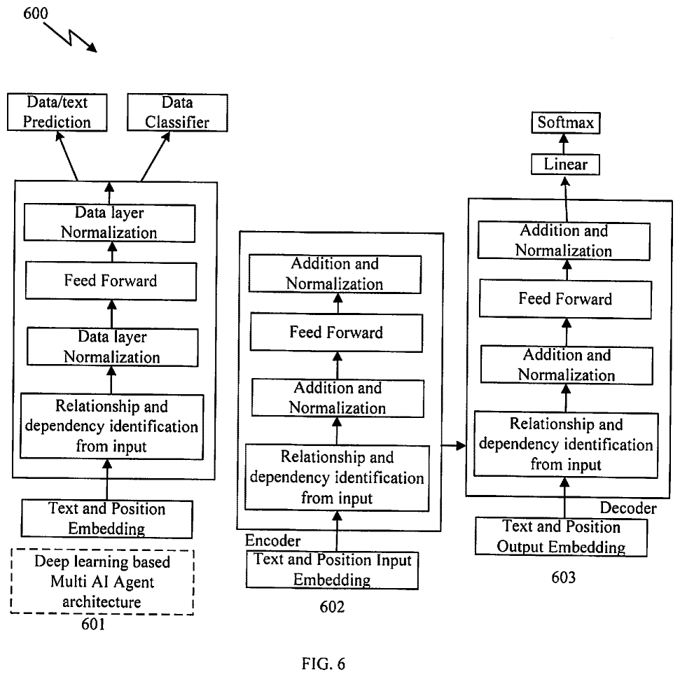

In an exemplary embodiment, the data processing system of the invention is configured for large-scale pre-training of models on supply chain and procurement domain data and adaptation to particular SCM tasks or sub domains. However, as larger models are pre-trained, full fine-tuning, which retrains all model parameters, becomes less feasible. In an advantageous aspect, Low-Rank Adaptation (LORA), is used which freezes the pre-trained model weights and injects trainable rank decomposition matrices into each layer of the deep learning based LLM architecture 600 as shown in FIG. 6. This greatly reduces the number of trainable parameters for downstream tasks. LORA significantly reduces the number of trainable parameters and the GPU memory requirements. LORA performs better despite having fewer trainable parameters, a higher training throughput, and, unlike adapters, no additional inference latency. Further, the data processing system facilitates integration of LORA with other models to provide efficient implementations and model checkpoints.

Referring to FIG. 6, a flow diagram 600 depicting a deep learning based multi AI agent architecture 601 with encoder 602 and decoder 603 is provided in accordance with an example embodiment of the invention. To process a text input with a deep learning AI model, it is tokenized into a sequence of words. These tokens are then encoded as numbers and converted into embeddings, which are vector-space representations of the tokens that preserve their meaning. Next, the encoder in architecture transforms the embeddings of all the tokens into a context vector. The context vector allows the model to attend to different parts of an input sequence to capture its relationships and dependencies. Using the context vector, the architecture decoder generates output based on data objects of the input. For instance, the data object of the input provided by the user acts as an intent identifier and lets the decoder produce the subsequent word that naturally follows. Then, the data processing system reuses the same decoder, but at this instance the intent identifier is the previously produced next word. This process is repeated to create an entire paragraph, starting from a leading sentence. The context vector is large so it can handle very complex concepts, and with many layers in its encoder and decoder. The LLM based on deep learning captures long-range dependencies between words, graphs elements and hence the model understands the context. Also, LLM generates text based on previously generated tokens.

In a related aspect, for training the models including augmenting the LLM, output of the context vector is fed into a feed-forward neural network, which performs a non-linear transformation to generate a new representation. To stabilize the training process, the output from each layer is normalized, and a residual connection is added to allow the input to be passed directly to the output, allowing the model to learn which parts of the input are most important.

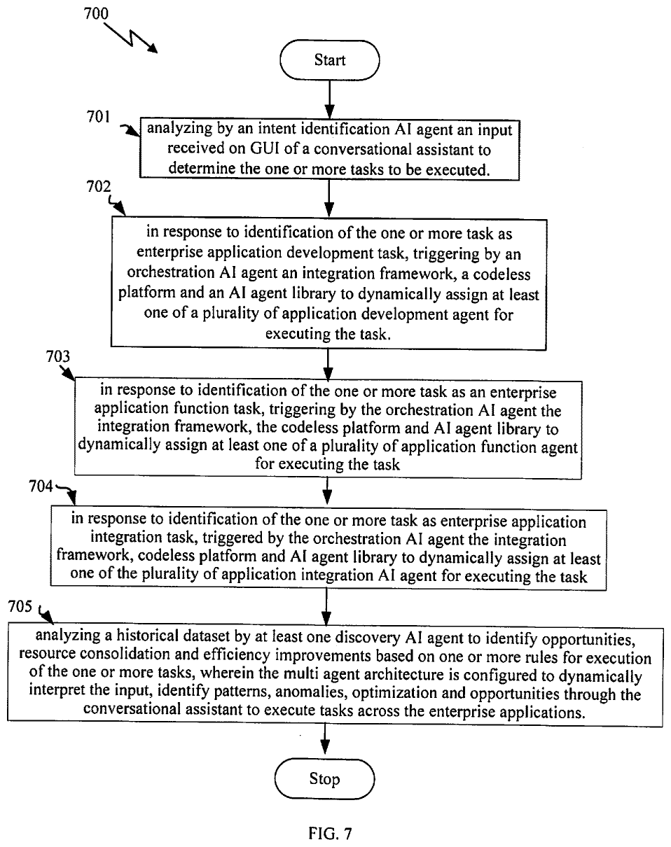

Referring to FIG. 7, a flow diagram 700 of a multi AI agent driven data processing method is provided in accordance with an embodiment of the invention. The method includes

Step S701 of analyzing by an intent identification AI agent an input received on GUI of a conversational assistant to determine the one or more tasks to be executed, step S702 of in response to identification of the one or more task as enterprise application development task, triggering by an orchestration AI agent an integration framework, a codeless platform and an AI agent library to dynamically assign at least one of a plurality of application development agent for executing the task. In S703, in response to identification of the one or more task as an enterprise application function task, triggering by the orchestration AI agent the integration framework, the codeless platform and AI agent library to dynamically assign at least one of a plurality of application function agent for executing the task. In S704, in response to identification of the one or more task as enterprise application integration task, triggered by the orchestration AI agent the integration framework, codeless platform and AI agent library to dynamically assign at least one of the plurality of application integration AI agent for executing the task, and in S705 analyzing a historical dataset by at least one discovery AI agent to identify opportunities, resource consolidation and efficiency improvements based on one or more rules for execution of the one or more tasks, wherein the multi agent architecture is configured to dynamically interpret the input, identify patterns, anomalies, optimization and opportunities through the conversational assistant to execute tasks across the enterprise applications.

In an embodiment, the data processing method includes predicting one or more supply chain scenarios intended to be executed by the user as the one or more tasks wherein a bot identifies one or more nodes of a data network linked to the one or more tasks for executing the scenarios.

In an embodiment, the one or more supply chain scenarios include spend analysis, sourcing, supplier management, opportunity identification, contract management, and negotiation as part of supply chain operations.

In an embodiment, the one or more AI agents communicate asynchronously sharing information about the one or more tasks, related dependencies and a conflict resolution mechanism to ensure uninterrupted operation.

In an embodiment, the one or more AI agents are enterprise applications AI agents such as Supply chain management application associated AI agents including document creation AI agent, recommendation AI agent, procurement policy AI agent, Workflow Visibility & Process Support AI Agent, Feedback Loop and Learning AI Agent, inventory management AI agent, supplier management AI agent, demand planning AI agent, supply planning AI agent, production planning AI agent and forecasting AI agent.

In an embodiment, the data processing method provides a bot configured to parse the application context and process one or more historical data for generating and storing, training artifacts and flow artifacts in an application context database wherein the bot processes the received input based on one or more application context data models to recontextualize the at least one LLM agent.

In an embodiment, parsing the application context includes predicting one or more supply chain scenarios intended to be executed by the user as the at least one task, the bot identifies one or more nodes of a data network linked to the at least one task for parsing the application context.

In an embodiment, the processing by an AI engine coupled to the processor, the one or more historical data and a user activity data from a data lake based on one or more supply chain application data models to generate code for a recommended strategy to execute the at least one task through prediction analysis.

In an embodiment, augmenting the at least one LLM agent further includes triggering by the orchestration agent, an AI agent architecture integrated to one or more tools configured for enabling a domain model AI agent, at least one application function AI agent and an execution AI agent to execute the task.

In an embodiment, for a task of adding a new field on an application interface, the processor is configured to trigger the domain model AI agent for defining the new field as part of a data structure by performing database queries; identifying by a form designer AI agent as the at least one application function AI agent, a location on the interface for adding the new field; and executing the tool by a Portal agent as the execution AI agent to automatically invoke API for publishing.

In an embodiment, the step of contextual processing for a supply chain operation task received as input, includes identifying one or more complex patterns in the input; determining one or more supply chain operation data object from the complex pattern; and triggering the contextual processing of the data objects by the at least one orchestration agent wherein the orchestration agent assigns the supply chain operation task associated with the identified data object to the at least one LLM agent.

In another embodiment, the response includes editable text for a user to modify thereby enabling the processor to determine attributes of the task to be executed.

In an embodiment, the conversational assistant is configured to recommend potential areas and anomalies to user for exploring thereby not only providing on-demand insights but also proactively guiding users toward critical areas that require attention and deeper analysis through Generative AI.

In another embodiment, wherein the conversational assistant is configured to receive a text, image or voice input wherein the image or voice input is converted to text by one or more processors for enabling augmenting the at least one LLM agent and identify the at least one task to be executed.

In an exemplary embodiment, the invention provides a data processing system having one or more processors; and one or more memory devices including instructions that are executable by the one or more processor for causing the processor to execute the data processing method or function. The data processing system of the invention includes a data abstraction layer configured for generating the relevant data objects and the response on the user interface, a multi-AI agent core having the at least one LLM agent configured for executing the one or more tasks; and the retrieval augmented Generation (RAG) Architecture and the Contextual retrieval augmented Generation (CAG) Architecture integrated to the AI agent core enabling one or more AI Agents to access and utilize real-time, external knowledge sources, to ensure responses are augmented with real time updated domain-specific data.

In an example embodiment, the present invention provides orchestration of AI enabled Agents supporting Autonomous buying process. The invention applies and updates procurement policies for buying or requesting process based on changes in regulations and organizational policies thereby allowing users to complete the process within the conversational view without having the requirement to create several rules and workflows to ensure compliant buying.

In an advantageous aspect, the AI enabled buying process on the orchestration engine leverages a plurality of intelligent agents to streamline user interactions within the enterprise application. Starting with the User Intent Extraction and Clarification Agents, the application interprets and confirms user requests, then direct the workflow through agents like the Buying Process Master Agent, Repeat Buy Analyzer, and Duplicate Transaction Analyzer to evaluate and optimize the purchasing process. Compliance and recommendation features, managed by the Procurement Policy Analyzer and Recommendation Engine, ensure adherence to company policies and provide informed purchasing options. The Buying Channel Decision Agent determines the best procurement method, while the Document Creation Assistant Agent facilitates document preparation, integrating feedback through the Feedback Loop & Learning Agent for continuous improvement and enhanced user experience. This approach ensures efficient, compliant, and user-friendly procurement operations.

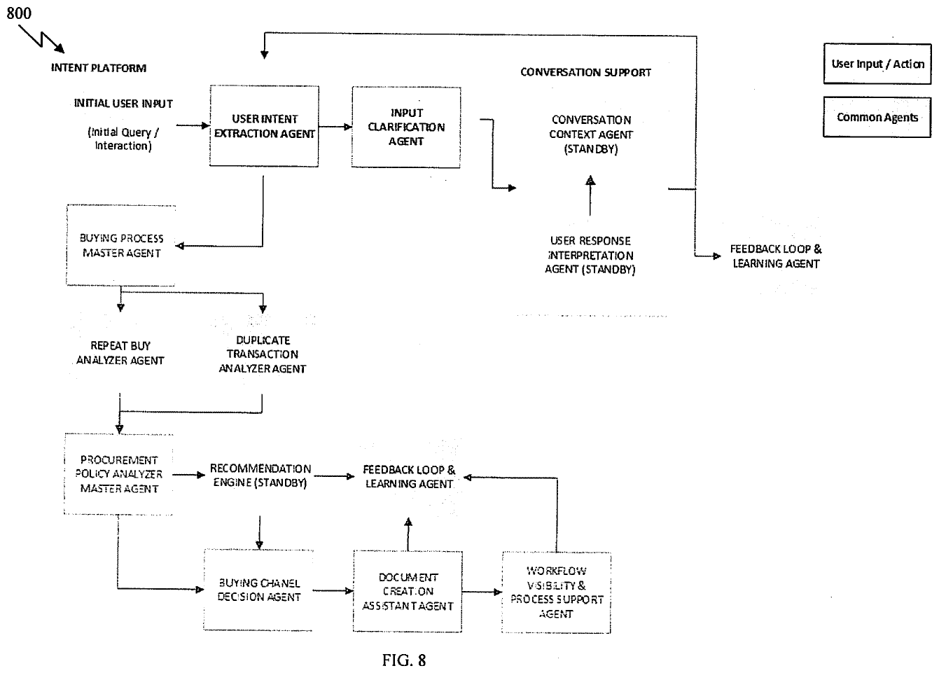

Referring to FIG. 8, the invention provides a block diagram 800 of an intent platform in accordance with an embodiment of the invention. The intent identification and extraction agent of the invention, analyzes user unput to extract key elements like users intended actions/queries and associated entities like supplier category, budget, and other relevant information. The User Intent Extraction Agent serves as the initial point of interaction between the user and the conversational AI system. Its primary function is to analyze the user's input and understand the goal from the user prompt and supporting document attached (if any) and to extract elements other relevant information. This agent ensures that the system accurately understands the user's requirements, setting the stage for subsequent actions. This includes Intent Classification to understand the user's goals, Persona/Access determination to understand functional guardrails, Named Entity Recognition for extracting specific terms Relevant for the action identified, Contextual Understanding to grasp nuances in user requests, supporting documents/images based Contextual understanding, and Support for Multi-lingual prompts.

In an embodiment, the present invention provides an input clarification Agent as AI agent configured to engage with the user to clarify incomplete or ambiguous inputs by asking targeted questions, providing options and ensuring the system has all the necessary information to proceed effectively. The Input Clarification Agent plays a critical role in ensuring that the system accurately understands and processes user queries, even when they are incomplete or ambiguous. This agent is responsible for interacting with the user to gather additional details, clarifying unclear inputs, and ensuring that the system has all the necessary information to proceed effectively. Clarification Request Mechanism is a fundamental component of this agent. When the system detects that a user's input is lacking essential details or is ambiguous, the Clarification Request Mechanism kicks in. This component generates specific follow-up questions aimed at obtaining the missing information to understand the user's intent. For example, if a user asks to “order more supplies” without specifying the type or quantity/item being requested, the agent might ask, “Could you please specify the type of supplies, and the quantity needed?”. The intent clarification Agent includes a Clarification request mechanism that generates specific follow-up questions aimed at obtaining the missing information or clarifying ambiguous inputs. The intent clarification Agent also includes context-aware Dialog management to ensure that the clarification process is smooth and contextually relevant, a disambiguation module that provides options or proposals to the user to solve ambiguity, a feedback loop that collects data on how users respond to the clarification questions and whether the follow up interactions successfully resolve ambiguities, and adaptive learning algorithms for continuously learning from user interactions to improve the clarification process.

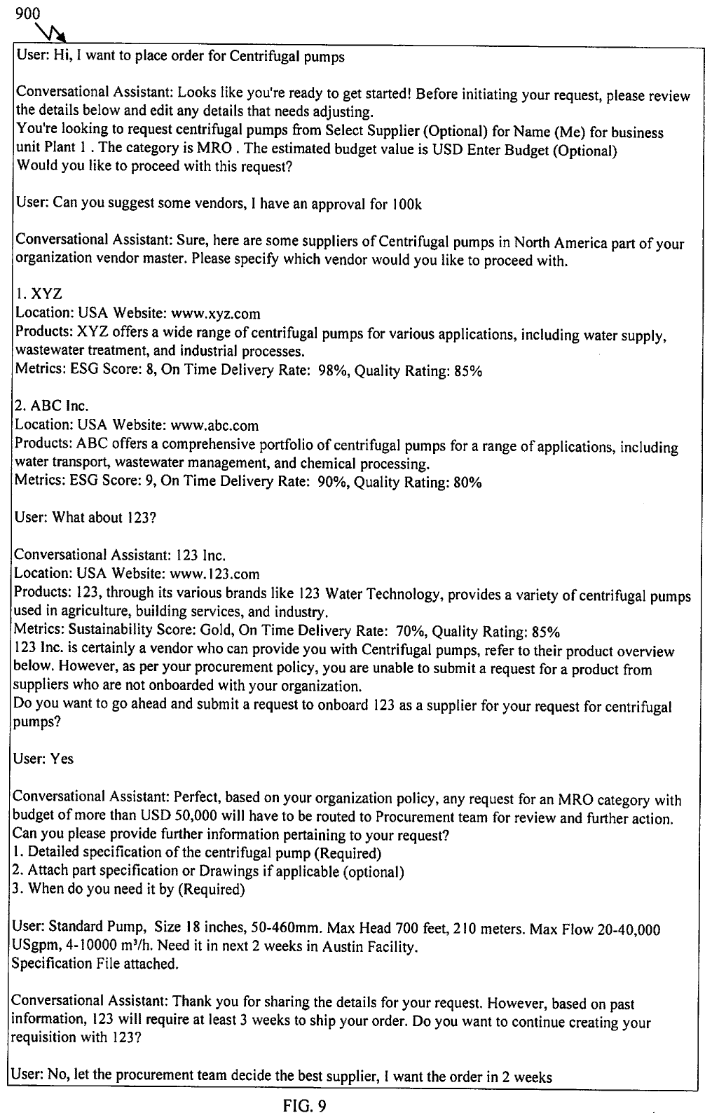

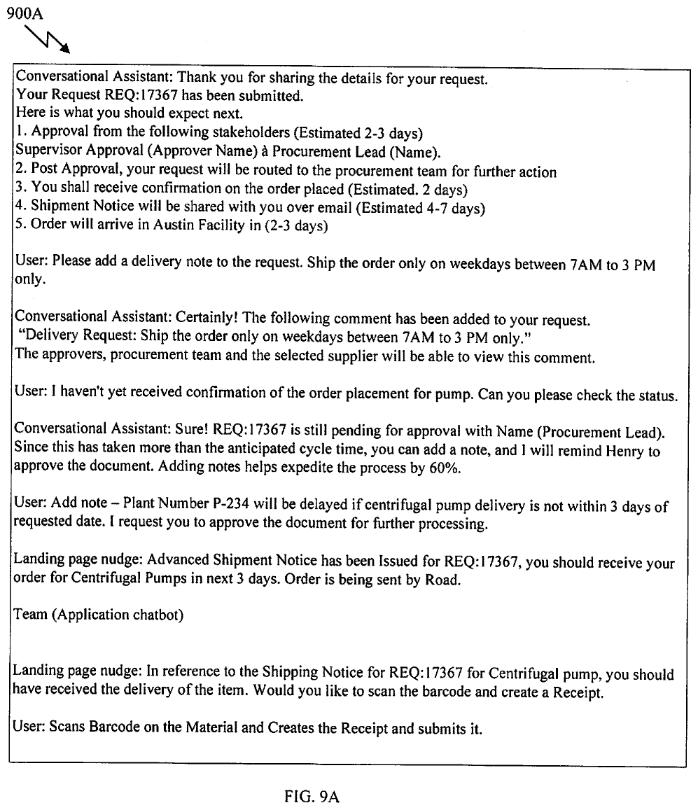

In an example embodiment, the AI agent of the data processing system and method includes a buying planner master AI agent with a conversation flow 900 and 900A on the GUI as shown in FIG. 9 and FIG. 9A. The Orchestration AI agent acts as the central coordinator of the conversational AI system, ensuring a seamless and efficient user experience throughout the interaction. This agent is responsible for managing the flow of the conversation by determining which agent should be activated based on the user's input and the context of the conversation. By orchestrating the various agents and managing the overall interaction, the Buying Planner/Orchestrator Agent helps users navigate the procurement process effectively. One of the critical functions of this agent is the Flow Control component, which analyzes user input and the current conversation state to decide the next steps. It employs a decision-making framework that identifies the most suitable agent or set of agents to handle the current part of the conversation. For example, when a user initiates a request for a new order, the Flow Control component may activate the User Intent Extraction Agent to gather key details from the user's input. The AI agent includes Flow Control by analyzing the conversation state and user input to determine the sequence of actions and which agents to activate, state management that maintains a structured record of all interactions, keeping track of the conversation state, user progress, and activated agents, Invocation Logic routing user queries and responses to the appropriate agents based on the current context and conversation stage, priority mechanism configured to manage the timing and priority of different tasks and agents, ensuring critical tasks are addressed promptly. This AI agent also ensures that the user is navigated back to the original intent and is not left mid flow without task completion due to non-contextual conversation. Also, the AI agent includes User Progress Tracking for Monitoring the user's progress through the procurement process, providing guidance and feedback at each stage.

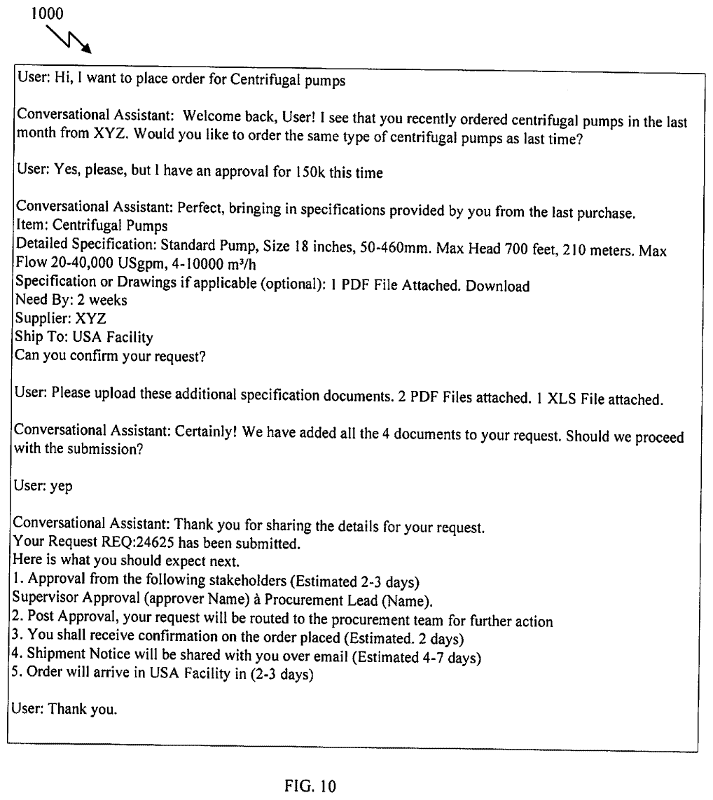

In another example embodiment, the AI agent of the data processing system and method includes a repeat buy AI agent with a conversational flow 1000 as shown in FIG. 10. The Repeat Buy AI Agent enhances the procurement experience by streamlining the process of repeat purchases. This agent identifies patterns in the user's previous requests and suggests efficient solutions for reordering items, saving time and effort. By recognizing recurring needs and providing tailored recommendations, the Repeat Buy Agent helps users maintain consistency in their purchasing activities. At the core of this agent is the Historical Data Analyzer, which examines the user's past requests and purchasing history to identify opportunities for repeat buys based on current requests. This component employs machine learning algorithms to detect frequently ordered items, preferred suppliers, and other relevant factors. For example, if a user regularly orders office supplies every month, the Historical Data Analyzer may identify this pattern and suggest a repeat purchase at the appropriate time. Not only that, but this agent also identifies users current request and suggests past purchases similar to the prior purchases to smoothen out user's requesting journey by prefilling most of the information required to complete the request. This AI agent includes a historical Data Analyzer that analyzes past requests and purchasing history to identify patterns and recurring needs, a pattern recognition engine that Detects similarities between current and past requests, determining the suitability for a repeat buy and a Repeat Buy Recommendation Engine configured to provide suggestions for reordering items, including preferred suppliers, existing contracts, and optimal quantities.

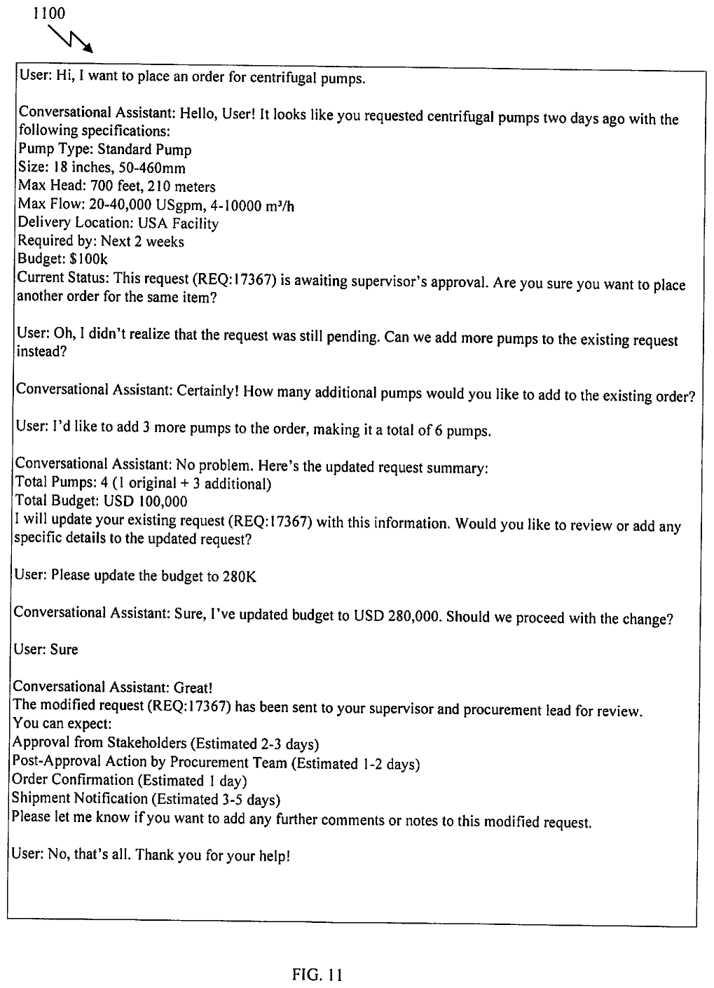

In yet another example embodiment, the AI agent of the data processing system and method includes a duplicate transaction analyzer AI agent conversational flow 1100 as shown in FIG. 11. The Duplicate Transaction Analyzer Agent helps users avoid creating duplicate buying requests by identifying similar unfulfilled requests placed in the recent past. This agent provides recommendations to users to either abort the current session or send a follow-up request on an existing order, streamlining the procurement process and reducing unnecessary duplication. One of the key components of this agent is the Historical Data Analyzer, which scans the user's recent transaction history to identify open or unfulfilled requests that are similar to the current query. This component utilizes natural language processing and machine learning algorithms to compare the details of the current request with past transactions. For instance, if a user attempts to place a request that is nearly identical to one, they submitted a week ago and is still pending, the agent might alert the user and suggest sending a follow-up instead. The AI analyzes past requests and purchasing history to identify patterns and recurring needs, also Scans recent transaction history to identify similar open or unfulfilled requests. The AI agent includes a Similarity Detection Engine configured to compare current requests with past transactions to evaluate similarity and determine duplicate status, a Duplicate Transaction Recommendation Engine that provides recommendations and alerts to the user based on the analysis, suggesting appropriate actions. The AI agent continues with recent requests or follow up on submitted but unfulfilled requests.

In an example embodiment, the AI agent includes a procurement policy analyzer agent configured to read and interpret the procurement policy uploaded by the user, regardless of format (e.g., PDF, Doc, Excel, plain text or combination of these documents). The AI agent is invoked once during setup of the buying process for a user and continuously invoked till required information to assess policy is entered by the user. The role is this agent is to ensure that all procurement activities adhere to organizational policies. It reads and interprets the procurement policies uploaded by the user, regardless of the document format, be it PDF, DOC, or XLSX, etc. By being able to handle various formats, and multiple policy documents, this agent provides flexibility and convenience for users, making it easier to enforce compliance without having the need to maintain complex rules in the procurement application. This agent will also analyze information provided by the user and see if that information is enough to pass to the following agent to assess Buying Policy. For Example: If the procurement policy is to check the budget of the purchase for certain categories, the application will request for user to enter the budget to proceed the buying process. This AI agent includes a document parsing engine to convert various formats into a machine-readable format, a policy parsing module to extract rules and guidelines from the policy and request for additional information from the user to assess the procurement policy correctly.

In an example embodiment, the AI agent is a buying channel decision AI agent configured to determine the most appropriate buying channel based on the user's requirements and the procurement policy. This agent ensures that the procurement process aligns with the most suitable purchasing method, whether it be catalog purchasing, contracted purchasing, punchout systems, or any of the request mechanism-sourcing request, project request, contract request or supplier request, thereby optimizing efficiency and compliance. The core of this agent is the decision engine which applies rules derived from the procurement policy to decide the appropriate buying channel. The decision engine evaluates various factors, including the type of product or service, budget constraints, and urgency, to determine the most efficient and cost-effective purchasing method. By adhering to these rules, the engine ensures that the procurement process is streamlined and compliant with organizational policies. This AI agent is configured for contextual matching to align user needs with available channels and close ties with the Procurement Policy agent to determine what further input is required from the user to determine the most compliant buying channel.

In another example embodiment, the AI agent is a recommendation engine AI agent (master agent) configured to guide a user through the supply chain process by suggesting relevant catalog items, suppliers, contracts, and other resources based on the user's input and the procurement policy. This agent enhances the user's experience by providing personalized and contextually relevant recommendations that streamline the buying process, ensures compliance with procurement policies and align with procurement policies and preferences. The recommendation engine AI agent analyzes the user's input, including their preferences and requirements, and leverages this information to suggest the most suitable items and suppliers. For instance, if a user indicates a need for “office furniture within a specific budget,” the engine analyzes the user's preferences, budget constraints, and procurement policies to recommend items from catalogs, available contracts, or preferred suppliers that best meet these criteria. This AI agent is invoked either as part of the buying process procurement policy, or Adhoc based on the user's conversation.

In a related embodiment the recommendation engine AI agent includes sub-AI agents such as Item recommendation AI agent, Supplier recommendation agent, Contract recommendation AI agent, user interface and interaction module AI agent, feedback and adaptability module AI agent, and learning mechanism AI agent.

The Item recommendation AI agent is configured to suggest relevant catalog and punchout items based on user input and procurement policies. It uses a combination of algorithms and business rules to match user requirements with available items. For example, if a user is looking for “environmentally friendly cleaning supplies,” the module will filter items in the catalog that meet this specific criterion, ensuring that the recommendations are both relevant and compliant with sustainability policies. The supplier recommendation AI agent is configured to find suitable suppliers based on user needs and procurement policies. It evaluates suppliers based on various factors, such as Relevant Category, delivery timelines, quality of goods or services, and compliance with procurement guidelines. For instance, if a user requires a fast delivery of a critical item, the Supplier Matching Engine will prioritize suppliers with a proven track record of timely deliveries. This Recommendation agent will also take into consideration all the guidelines set by the organization while recommending a supplier-such as relevance for a Business Unit, preferred Supplier Flag, Involvement of the Supplier in delivering similar items/service in the past, etc. The contract recommendation AI agent is configured for proposing relevant contracts based on the user's requirements and procurement policies. It identifies existing contracts that can fulfill the user's needs, helping to streamline the buying process and ensure compliance with procurement guidelines. For example, if a user needs to procure “IT services,” the module will recommend contracts with vetted IT service providers that have favorable terms and conditions. The contract recommendation agent will take into consideration relevance of the contract and its guardrails to ensure only relevant master agreements/SOWs are recommended. The user interface and interaction module are configured to present the recommendations to the user in a clear and intuitive manner, allowing users to easily review and select the suggested options. It also provides users with the flexibility to modify the recommendations based on their specific needs and preferences. For example, the user interface will present the recommended items in a ranked list, with filters and sorting options to help the user find the best match quickly. All embedded within the conversation experience to allow users to continue the process seamlessly. The feedback and adaptation module AI agent is configured to gather user feedback on the recommendations provided and uses this feedback to fine-tune the recommendation algorithms and processes. It ensures that the system remains responsive to user needs and preferences, improving the overall user experience over time. For instance, if a user indicates that a recommended supplier failed to meet their expectations (via a Thumbs down Response), or the user is not selecting any suppliers from the recommendation the Feedback and Adaptation Module will adjust the supplier's ranking in future recommendations. The learning mechanism AI agent is configured to continuously learn from user feedback and historical data to improve the accuracy and relevance of the recommendations. It adapts to changing user preferences, procurement policies, ensuring that the recommendations remain up-to-date and effective. For instance, if a user consistently prefers a specific supplier for a particular type of product, the learning mechanism will prioritize that supplier in future recommendations.

In an embodiment, the AI agent is document creation assistant (Master) AI agent configured to create requisitions or any other buying/requesting documents. This agent streamlines the document creation process by providing templates, generating documents based on user input and recommendations, and ensuring accuracy and compliance to the procurement policy and the rules setup for the respective document submission. Further, within the Buying/Requesting process, one of more documents can be created by the user, such as requisition (catalog or non-catalog-based requisition), Quick Quote, request Form including Generic Request, Sourcing Request, project request, contract request, Supplier Request, and payment request. This AI agent includes Domain model linked Template Manager configured to provide standard document templates tailored to various procurement scenarios based on the above-mentioned document's domain model. These templates ensure consistency and compliance with organizational standards, making it easier for users to create documents that meet all necessary requirements. By offering pre-configured templates, the system reduces the time and effort involved in document creation. For example, When the Buying Channel is a requisition, the application will request user to enter Accounting Details-like Company Code, Plant, etc. Application will suggest default values and user must confirm/modify to proceed. When the Buying channel is Quick Quote, the application will suggest relevant suppliers (within and outside of the supplier network of the organization) to be invited to the bidding process. Users can confirm/add new vendors/modify vendors; users can add attachments with further bid specifications and proceed with publishing bid.

This AI agent also includes a document preview generator configured to fill in details based on user input and recommendations from other agents. This component automatically populates the templates with relevant information, such as item descriptions, supplier details, accounting details and pricing, ensuring that all necessary details are accurately captured. This automation streamlines the document creation process and minimizes the burden on the users to fill in lengthy forms. Further, the AI agent also includes a review and Validation Mechanism that ensures document accuracy and compliance with procurement policies. This component cross-checks the generated documents against the extracted policy rules and user input to identify any discrepancies or missing information. The review and validation mechanism also verifies the forms filled with the rules set up by the organization policies and procedures on creation of various mentioned documents. By validating the documents before finalization, the system ensures that all procurement activities are conducted within established guidelines, reducing the risk of non-compliance.

In an embodiment, the AI agent includes a conversation context manager AI agent configured to maintain context through the conversation with the conversation assistant, ensuring relevance and tracking user inputs continuously to complete the task identified in the intent. The Conversation Context Manager is a critical agent within the AI-driven procurement system, designed to maintain and manage contextual information throughout the user's interaction. This agent ensures that the system comprehensively understands and remembers the user's intent, preferences, and any ongoing conversation threads, providing continuity and relevance in responses and suggestions. By doing so, the Conversation Context Manager significantly enhances the user experience by ensuring consistency and relevance across multiple interactions. This agent operates behind the scenes, tracking the conversation history, user input, and the state of the conversation to ensure that the system provides accurate and contextually appropriate responses. This AI agent includes intent disambiguation for utilizing follow-up queries to handle ambiguous utterances, thereby understanding user's intent more accurately. The system should intelligently present alternative intents through “Did you mean” suggestions to guide the user in the right direction. The AI agent also includes a state management system to handle different stages of the buying process and ability to maintain the stages in the workflow on standby when user deviates to a different conversation. Further, the AI agent provides contextual understanding improving conversational interaction capabilities to understand user queries contextually and handle complex, multi-step requests. The AI agent anticipates and suggests next steps based on the conversation's context and user behavior. Memory Management to remember relevant details across interactions leading to better conversational experience. The AI agent includes document-based Contextual Understanding for enhancing conversational capabilities to identify the intent behind user requests that include attachments. Analyze document types such as Images of the item/parts, quotes, Statements of Work (SOW), contracts, and invoices, etc. and extract metadata and relevant information for further processing. The AI agent provides multi-language support by extending conversational capabilities to support multiple languages, catering to users in different locations.

In an exemplary embodiment, the AI agent of the present invention includes workflow visibility and process support agent. This agent is designed to streamline the procurement process by providing comprehensive visibility into ongoing processes, automating approval workflows, and managing escalations efficiently. This agent includes process & workflow visibility providing users with a clear and concise view of the status of their requests and ongoing processes. It uses a stepper-like indicator to display the progress of each request, including completed tasks, pending approvals, and estimated timelines for each stage. This visual representation helps users understand where their request stands in the workflow and what to expect next. For instance, if a user has submitted a procurement request, the Process & Workflow Visibility component will show the current stage of the request, such as “Supervisor Approval” or “procurement team review,” along with the estimated time for each stage. Further, this AI agent includes escalation management and nudges that automates the escalation process by identifying potential delays or bottlenecks in the approval workflow and taking proactive measures to resolve them. It can send automated reminders or nudges to the relevant stakeholders, ensuring that the approval process remains on track and that any issues are addressed promptly.

In an exemplary embodiment, the AI agent includes a feedback loop and learning agent of the AI-driven procurement system, dedicated to continuously refining and enhancing the system based on user interactions and feedback. By incorporating user feedback and monitoring system performance, the Feedback Loop and Learning Agent helps to create a more responsive and user-friendly experience. The primary function of the Feedback Loop and Learning Agent is to collect feedback from users, analyze it, and use this information to make informed updates and adjustments to the system. This agent actively engages with users to understand their level of satisfaction with the system's responses and actions on every stage, ensuring that any issues or areas for improvement are identified and captured. For instance, if users consistently provide negative feedback about certain recommendations or actions, the agent analyzes this feedback to identify the root causes and adjust the system accordingly. This AI agent includes Thumbs Up & Thumbs Down Feature as a feedback mechanism where users can rate their experience with the orchestration layer's responses and actions by providing a thumbs-up or thumbs-down. It also includes feedback capture and analysis enabling the System to capture detailed feedback from users who provide a thumbs-down rating. This feedback must include specific reasons for their dissatisfaction and suggestions for improvement. The reasons Category will differ for different intents and different conversations or scenarios within the conversation. Further the AI agent provides aggregated feedback analysis and model refinement where aggregated feedback data is used to analyze common issues and patterns in user interactions. Implement a continuous learning model that refines the AI's understanding and capabilities based on this analysis.

In an advantageous aspect, the multi-AI agent architecture ensures that the system is adaptive and responsive, providing users with a smooth and intuitive buying process while adhering to procurement policies and guidelines.

In an example embodiment, the present invention provides orchestration of AI enabled Agents supporting Spend analysis and opportunity identification process of enterprise application. The spend Analysis AI agent empowers users by providing real-time insights into their organization's spending patterns. Traditionally, spend analysis required specialized tools and deep knowledge of procurement systems. The conversational AI-driven approach enables users to gain insights simply by asking questions, making it accessible to a broader audience. The AI agents include user intent identification and extraction agent. When the user asks, “Show me the summary of spending across categories like region, supplier, and payment terms,” this agent extracts key parameters such as “category,” “region,” “supplier,” and “payment terms.” The AI agents also include a Spend analysis Agent configured to aggregate spend data across parameters specified in the user input. It provides insights such as anomalies (e.g., “detect anomalies in MRO spending”), key metrics (e.g., “supplier diversity spend”), and cost-optimization opportunities (e.g., “cost avoidance in travel spend”). The AI agent also includes a procurement policy analyzer agent configured to ensure that the spend data presented complies with internal procurement policies. If the user requests a non-compliant action, the agent provides recommendations aligned with company policies. The proactive recommendation agent as the AI agent recognizes patterns from the spend data, to automatically recommend additional insights, such as “XYZ spending observed in Q3” or “Consulting services spending increased by 150% over last year.” These insights are presented in a conversational format, enabling real-time decision-making. For Example: A user inputs, “Show me the anomalies in MRO spending.” The system identifies areas where there has been maverick spending, over-budget purchases, or delays in supplier payments. If anomalies are detected, the user is notified with a detailed breakdown and recommendations to address them.

The system also proactively suggests areas for further exploration, such as “Diverse spend reduced by more than 50% in EMEA.” The AI agent includes opportunity discovery agent configured to scan procurement data to identify opportunities for vendor consolidation, payment term normalization, or other cost-saving measures, recommend RFP drafting for consolidated categories and suggest payment schedules for suppliers to optimize cash flow. The AI agent includes a recommendation Engine (Master Agent) configured to offer suggestions for actions like issuing RFPs or adjusting payment terms. It continuously learns from user responses and refines recommendations accordingly. For Example: A user asks, “Recommend payment term normalization opportunities.” The system analyzes the existing supplier contracts and suggests suppliers whose payment terms could be extended or reduced to match company standards, improving liquidity and cash management. Further, the AI agent also includes a proactive opportunity discovery AI agent that is configured to automatically generate actionable insights without prompting. For example, for procurement teams, the system suggests “Cost Saving Opportunities” like vendor consolidation or contract compliance reviews. For sourcing managers, it identifies “Inclusion opportunities for diverse suppliers in ongoing RFPs.” For category managers, it highlights contracts nearing expiry and suggests opportunities for renegotiation.

In an example embodiment, the present invention provides orchestration of AI enabled Agents supporting Budget management process of enterprise application. The system enables integration of advanced AI-driven agents for real-time budget checks, notifications, predictive analysis, and proactive recommendations for budget optimization. When a budget is not available, the system involves agents that notify relevant stakeholders (Procurement Lead, Budget Manager) and suggest alternative budget sources or transfers. The AI agent includes a budget check AI agent configured to verify whether the request is within the available budget for the specified function, project or category and ensures compliance with financial limits. For each procurement request, the agent checks the associated budget category (e.g., marketing, IT, or operations) and ensures the funds are sufficient. If the funds are insufficient, the AI agent pauses the request and triggers the Budget Notification and Escalation AI Agent for sending automatic notification. The budget notification and escalation AI agent provides insights into the fast-consuming budget categories and highlights areas that need attention, such as rapidly depleting funds or budgets predicted to be exhausted in future. It also includes a future use prediction module that forecasts usage trends based on historical spending patterns analyzed by predictive spend analyzer. The AI agent includes an alternative Budget Recommendation AI Agent configured to identify alternative budget categories that are underutilized and not expected to be consumed, offering potential budget transfer options. The AI agent also includes a budget transfer approval AI agent configured to track status of the transfer through approval workflow engine and update the enterprise application process accordingly.

In an embodiment, the budget management AI agent includes a spend Cap Notification AI Agent configured to send proactive notifications when spending in certain categories (e.g., office supplies or IT services) is approaching or exceeding predefined caps, preventing overspending by alerting users before they submit procurement requests that would violate spend limits and automatically adjusts spend caps based on patterns in usage, ensuring dynamic budget control. The AI agent includes a historical spend trend agent configured to highlight categories that consistently experience high or low spending during certain periods (e.g., holiday promotions, IT infrastructure upgrades) and recommend budget reallocation ahead of time to meet seasonal demands without disrupting procurement processes. The AI agent includes a real-time budget rebalancer AI Agent configured to continuously monitor budget consumption and automatically rebalances budgets based on real-time spending across departments or categories. For example, if one department is underspending and another is overspending, the Real-Time Budget Rebalancer Agent reallocates excess funds where they are needed most. It helps organizations avoid overage charges and underutilized funds by ensuring budget usage is dynamically optimized. This AI agent predicts and prevents budget shortfalls before they occur by suggesting micro-adjustments in real-time. Further, the budget management AI agent also includes an audit Trail and Compliance Agent configured to track all budget-related actions, including budget checks, transfers, and approvals, providing a complete audit trail for compliance and reporting. It logs every budget approval, transfer, and notification for future review and ensures the organization adheres to its internal financial policies and external regulatory requirements. The agent automatically generates periodic compliance reports that are sent to the finance and audit teams.

In an advantageous aspect, the Multi AI agent architecture for budget management ensures that procurement requests are processed efficiently, even in cases where budgets are strained or unavailable. Through predictive analysis, proactive notifications, and real-time recommendations, it enhances financial control while enabling seamless procurement activities.

In an embodiment, the present invention provides AI agents for Sourcing, contracting, procure to pay, supplier management, third party risk management, should cost modelling and price library management.

In an exemplary embodiment, the present invention may be a system, a method, and/or a computer program product for data processing in enterprise application. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A Multi agent architecture for data processing in enterprise applications developed by codeless platform, the architecture comprising:
at least one memory comprising:
an integration framework configured for integrating one or more elements of a plurality of enterprise applications through application programming interfaces enabling interaction and exchange of information across the plurality of enterprise applications wherein the integration platform enables bidirectional data flow and interoperability thereby aggregating and synchronizing data from distinct sources for executing one or more tasks;
an AI agent library configured to store a plurality of AI agents for selection, customization and deployment based on the one or more tasks to be executed wherein the plurality of AI agent includes at least one intent identification AI agent, an orchestration AI agent, one or more application function AI agent, one or more application development AI agent, one or more application integration AI agent and a discovery AI agent;
a plurality of configurable components of a codeless platform triggered by the plurality of AI agents for executing the one or more tasks; and
at least one processor configured to:
cause the at least one intent identification AI agent to analyze an input received on GUI of a conversational assistant to determine the one or more tasks to be executed;
in response to identification of the one or more task as enterprise application development task, triggering by the orchestration AI agent the integration framework, codeless platform and AI agent library to dynamically assign at least one of the plurality of application development AI agent for executing the task;
in response to identification of the one or more task as enterprise application function task, triggering by the orchestration AI agent the integration framework, codeless platform and AI agent library to dynamically assign at least one of the plurality of application function AI agent for executing the task;
in response to identification of the one or more task as enterprise application integration task, triggered by the orchestration AI agent the integration framework, codeless platform and AI agent library to dynamically assign at least one of the plurality of application integration AI agent for executing the task;
analyze a historical dataset by the at least one discovery AI agent to identify opportunities, resource consolidation, efficiency improvements and one or more data objects based on one or more rules for execution of the one or more tasks,
wherein the multi agent architecture is configured to dynamically interpret the input, identify patterns, anomalies, optimization and opportunities through the conversational assistant to execute tasks across the enterprise applications.

2. The architecture of claim 1, wherein the plurality of AI agents include a recommendation engine AI agent configured for processing the one or more task and recommend contextually relevant options to the user.

3. The architecture of claim 1, wherein the plurality of application development agents of the AI agent library include configurable components AI agent, form builder AI agent, workflow creation AI agent, Layout Manager AI agent, Expression Builder Component AI agent, Field & Metadata Manager AI agent, store-manager AI agent, Internationalization Component AI agent, Theme Selector Component AI agent, Notification Component AI agent, Custom Field Component & Manager AI agent, Dashboard Manager AI agent, Code Generator and Extender AI agent, Scheduler AI agent, and form Template manager AI agent.

4. The architecture of claim 1, wherein the plurality of application functional agents of the AI agent library includes document creation AI agent, recommendation AI agent, procurement policy AI agent, Workflow Visibility & Process Support AI Agent, Feedback Loop and Learning AI Agent, inventory management AI agent, supplier management AI agent, demand planning AI agent, supply planning AI agent, production planning AI agent, forecasting AI agent, third party risk management AI agent, should cost modeling AI agent, procure to pay AI agent, sourcing AI agent, and Contracts AI agent.

5. The architecture of claim 1, wherein the architecture is configured to scale for dynamic addition and removal of the plurality of AI agents based on a system load and operational requirements as the architecture supports integration of the AI agents through a modular framework.

6. The architecture of claim 1, wherein the AI agents are equipped with adaptive learning capabilities, utilizing machine learning techniques to enhance AI agents recommendation accuracy based on user interactions.

7. The architecture of claim 1, wherein the one or more tasks are dynamically assigned by the orchestration agents and executed by the plurality of AI agents based on real-time analysis of the input, system conditions, and operational rules.

8. The architecture of claim 1, further comprises:
a nudging and notification module configured to autonomously analyze real-time data and historical patterns to generate and deliver timely nudges and notifications to users by initiating prompts and suggestions for user actions or considerations without requiring explicit user initiation, leveraging predictive analytics and behavioral insights to enhance user engagement and decision-making.

9. The architecture of claim 1, wherein the codeless platform is configured to enable the at least one processors for codeless application development, the codeless platform includes:
a customization layer; an application layer; a shared framework layer; a foundation layer; a data layer; and an application orchestrator; wherein the one or more processors is configured to cause the plurality of configurable components to interact with each other in a layered architecture to:
customize the one or more application based on at least one operation to be executed using the customization layer;
organize at least one application service of the one or more application by causing the application layer to interact with the customization layer through one or more configurable components of the plurality of configurable components, wherein the application layer is configured to organize the at least one application service of the one or more application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more application using the application orchestrator to enable interaction of the plurality of configurable components in the layered architecture.

10. The architecture of claim 1, further comprises:
a data abstraction layer configured for generating the data objects and the response on the user interface;
a micro-AI agent core having the AI agent library configured for executing the one or more tasks; and
a retrieval augmented Generation (RAG) Architecture and a Contextual retrieval augmented Generation (CAG) Architecture integrated to the micro-AI agent core enabling one or more Micro AI Agents to access and utilize real-time, external knowledge sources, to ensure responses are augmented with real time updated domain-specific data.

11. The architecture of claim 1, wherein different parts of the AI agent are distributed across a plurality of GPU (Graphics processing Units) for parallel training including data parallelism, sequence parallelism, pipeline parallelism and tensor parallelism.

12. The architecture of claim 11, wherein the system is provided in a cloud or cloud-based computing environment.

13. A method of multi AI agent architecture driven data processing in enterprise applications developed by a codeless platform, the method comprising:
analyzing by an intent identification AI agent an input received on GUI of a conversational assistant to determine the one or more tasks to be executed;
in response to identification of the one or more task as enterprise application development task, triggering by an orchestration AI agent an integration framework, a codeless platform and an AI agent library to dynamically assign at least one of a plurality of application development agent for executing the task;
in response to identification of the one or more task as an enterprise application function task, triggering by the orchestration AI agent the integration framework, the codeless platform and AI agent library to dynamically assign at least one of a plurality of application function agent for executing the task;
in response to identification of the one or more task as enterprise application integration task, triggered by the orchestration AI agent the integration framework, codeless platform and AI agent library to dynamically assign at least one of the plurality of application integration AI agent for executing the task;
and
analyzing a historical dataset by at least one discovery AI agent to identify opportunities, resource consolidation and efficiency improvements based on one or more rules for execution of the one or more tasks, wherein the multi agent architecture is configured to dynamically interpret the input, identify patterns, anomalies, optimization and opportunities through the conversational assistant to execute tasks across the enterprise applications.

14. The method of claim 13, wherein the conversational assistant is configured to recommend potential areas and anomalies to user for exploring thereby not only providing on-demand insights but also proactively guiding users toward critical areas that require attention and deeper analysis through Generative AI.

15. The method of claim 13, wherein the conversational assistant is configured to receive a text, image or voice input wherein the image or voice input is converted to text by one or more processors for enabling augmenting the at least one LLM agent and identify the at least one task to be executed.

16. The method of claim 13, further comprises predicting one or more supply chain scenarios intended to be executed by the user as the one or more tasks wherein a bot identifies one or more nodes of a data network linked to the one or more tasks for executing the scenarios.

17. The method of claim 16, wherein the one or more supply chain scenarios include spend analysis, sourcing, supplier management, opportunity identification, contract management, and negotiation as part of supply chain operations.

18. The method of claim 13, wherein the one or more AI agents communicate asynchronously sharing information about the one or more tasks, related dependencies and a conflict resolution mechanism to ensure uninterrupted operation.

19. The method of claim 13, wherein a response on the GUI by the conversational assistant includes editable text for a user to modify thereby enabling a processor to determine attributes of the task to be executed.

20. A system of multi AI agent architecture driven data processing in enterprise applications developed by a codeless platform, the system comprising:
one or more processors; and
one or more memory devices including instructions that are executable by the one or more processor for causing the one or more processors to:
analyze by an intent identification AI agent an input received on GUI of a conversational assistant to determine the one or more tasks to be executed;
in response to identification of the one or more task as enterprise application development task, trigger by an orchestration AI agent an integration framework, a codeless platform and an AI agent library to dynamically assign at least one of a plurality of application development agent for executing the task;
in response to identification of the one or more task as an enterprise application function task, trigger by the orchestration AI agent the integration framework, the codeless platform and AI agent library to dynamically assign at least one of a plurality of application function agent for executing the task;
in response to identification of the one or more task as enterprise application integration task, trigger by the orchestration AI agent the integration framework, codeless platform and AI agent library to dynamically assign at least one of the plurality of application integration AI agent for executing the task;
and
analyze a historical dataset by at least one discovery AI agent to identify opportunities, resource consolidation and efficiency improvements based on one or more rules for execution of the one or more tasks, wherein the multi agent architecture is configured to dynamically interpret the input, identify patterns, anomalies, optimization and opportunities through the conversational assistant to execute tasks across the enterprise applications.
